(19) United States
(12) Patent Application Publication
(10) Pub. No.: US 2025/0242625 A1
(43) Pub. Date: Jul. 31, 2025

(54) THERMAL TRANSFER RECORDING MEDIUM AND PRINTING DEVICE

(71) Applicants: BROTHER KOGYO KABUSHIKI KAISHA, Nagoya-shi, Aichi (JP); General Co., Ltd., Osaka (JP)

(72) Inventors: Satoru ITO, Nagoya-shi, Aichi (JP); Masaya FUJITA, Nagoya-shi, Aichi (JP); Mina KATAOKA, Nagoya-shi, Aichi (JP); Haruki MATSUMOTO, Nagoya-shi, Aichi (JP); Yuki HOKARI, Nagoya-shi, Aichi (JP); Hiroaki NARUSE, Osaka-shi, Osaka (JP); Jiro HIRANO, Osaka-shi, Osaka (JP)

(73) Assignees: BROTHER KOGYO KABUSHIKI KAISHA, Nagoya-shi, Aichi (JP); General Co., Ltd., Osaka (JP)

(21) Appl. No.: 18/854,147

(22) PCT Filed: Apr. 27, 2023
(86) PCT No.: PCT/JP2023/016620

§ 371 Date: Oct. 4, 2024

(30) Foreign Application Priority Data
Apr. 28, 2022 (JP) 2022-075256

(51) Int. Cl. B41M 5/382; B41J 2/325

(52) U.S. Cl. CPC B41M 5/38214; B41J 2/325; B41M 5/38228; B41M 2205/30

(57) ABSTRACT

There is provided a thermal transfer recording medium that is ruptured between a first ink layer and a base material layer or in the first ink layer when an external force is applied to the base material layer and the second ink layer in a direction in which the layers are separated from each other, in a first state in which the thermal transfer recording medium is heated to a first temperature or higher and a second temperature or lower and then cooled to a third temperature or lower. The thermal transfer recording medium is ruptured between the first ink layer and the second ink layer or in the second ink layer when the external force is applied in a second state in which the thermal transfer recording medium is heated to a temperature above the second temperature and then cooled to the third temperature or lower. A total thickness of all layers that are ruptured in the second state and are separated from the base material layer side is thicker than a thickness of any layer before thermal transfer except for the base material layer in a portion remaining without being separated from the base material layer.

### CROSS REFERENCE TO RELATED APPLICATIONS

The present application corresponds to Japanese Patent Application No. 2022-075256 filed in the Japan Patent Office on Apr. 28, 2022, the entire disclosure of which is incorporated herein by reference.

### TECHNICAL FIELD

The present disclosure relates to a thermal transfer recording medium enabling characters having different colors to be recorded, and a printing device to transfer the thermal transfer recording medium to a printing medium.

### BACKGROUND ART

For example, each of Patent Literatures 1 and 2 discloses a thermal transfer recording medium capable of recording characters having different colors (for example, two colors including black and red). This type of thermal transfer recording medium is set in a dedicated printing device. Characters having different colors can be transferred to a printing medium by adjusting an energy amount applied to a thermal head of the printing device.

### CITATION LIST

### Patent Literatures

Patent Literature 1: Japanese Patent Application Publication No. 2000-094843
Patent Literature 2: Japanese Patent Application Publication No. S62-227788
Patent Literature 3: Japanese Patent Application Publication No. S63-214481

### SUMMARY OF INVENTION

### Technical Problem

A preferred embodiment of the present disclosure provides a thermal transfer recording medium enabling characters having two colors to be recorded, the thermal transfer recording medium being capable of preventing a fringe of one color from appearing at the time of transfer of the other color.

### Solution to Problem

A thermal transfer recording medium according to a preferred embodiment of the present disclosure is formed by layering a base material layer, a first ink layer including first ink, and a second ink layer including second ink in this order in which at least a part of the first ink layer and the second ink layer is thermally transferred to a printing medium. The thermal transfer recording medium is ruptured between the first ink layer and the base material layer or in the first ink layer when an external force is applied to the base material layer and the second ink layer in a direction in which the layers are separated from each other, in a first state in which the thermal transfer recording medium is heated to a first temperature or higher and a second temperature or lower and then cooled to a third temperature or lower. The thermal transfer recording medium is ruptured between the first ink layer and the second ink layer or in the second ink layer when the external force is applied in a second state in which the thermal transfer recording medium is heated to a temperature above the second temperature and then cooled to the third temperature or lower. A total thickness of all layers that are ruptured in the second state and are separated from the base material layer side is thicker than a thickness of any layer before thermal transfer except for the base material layer in a portion remaining without being separated from the base material layer.

### Advantageous Effects of Invention

According to the thermal transfer recording medium of a preferred embodiment of the present disclosure, it is possible to prevent a fringe of one color of characters having two colors from appearing at the time of transfer of the other color.

### BRIEF DESCRIPTION OF DRAWINGS

FIG. 1 is a view schematically illustrating a structure of a printing device according to a preferred embodiment of the present disclosure.

FIG. 2 is a block diagram illustrating an electrical configuration of the printing device.

FIG. 3 is a schematic view illustrating a heating step and a cooling step of the printing device.

FIGS. 4A and 4B are schematic views illustrating a cooling step and a transferring step of the printing device.

FIGS. 5A and 5B are views illustrating an example of a printing pattern of the printing device.

FIG. 6 is a view illustrating a fringe pattern appearing at the time of thermal transfer.

FIG. 7 is a view illustrating a circuit pattern of a heating element of a thermal head in FIG. 3.

FIG. 8 is a diagram for illustrating a temperature distribution in the heating element in FIG. 7.

FIG. 9 is a diagram for illustrating how heat is transferred from the thermal head to a thermal transfer recording medium.

FIG. 10 is a graph illustrating a relationship between a reached heating temperature and a peeling force (adhesive force) at a plurality of layer boundaries of the thermal transfer recording medium.

FIG. 11 is a diagram for illustrating an appearing principle of the fringe.

FIG. 12 is a diagram for illustrating a countermeasure against the fringe.

FIG. 13 is a schematic cross-sectional view illustrating a layer configuration of a thermal transfer recording medium according to a preferred embodiment of the present disclosure.

FIG. 14 is a graph illustrating a relationship between an elapsed time and a reaching temperature of the thermal transfer recording medium in the heating step and the cooling step.

FIG. 15 is a view illustrating a peeling state of the thermal transfer recording medium.

FIG. 16 is a view illustrating a peeling state of the thermal transfer recording medium.

FIG. 17 is a view illustrating a peeling state of the thermal transfer recording medium.

FIG. 18 is a view illustrating a peeling state of the thermal transfer recording medium.

FIG. 19 is a view illustrating a peeling state of the thermal transfer recording medium.

### DESCRIPTION OF EMBODIMENTS

Next, preferred embodiments of the present disclosure will be described in detail with reference to the accompanying drawings.

### [Overall Configuration of Printing Device 1]

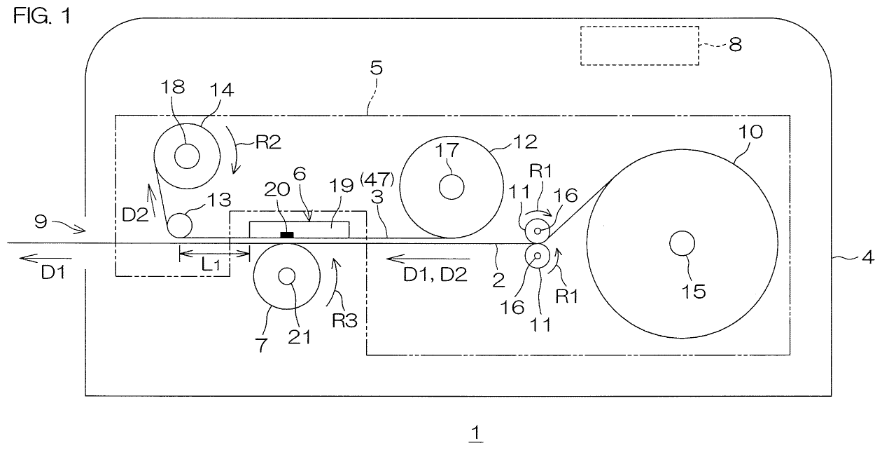

FIG. 1 is a view schematically illustrating a structure of a printing device 1 according to a preferred embodiment of the present disclosure.

With reference to FIG. 1, the printing device 1 is a thermal transfer printer that thermally transfers ink of an ink ribbon 3 as characters to a printer tape 2 as an example of a printing medium. The printer tape 2 may include, for example, a band-shaped film tape including a base material to which ink is directly transferred, a paper label tape in which a large number of paper labels are arranged on a band-shaped base film, and the like.

Examples of characters to be recorded on the printer tape 2 may include a typical character, a symbol such as a barcode or a QR code (registered trademark), a number, a figure, a pattern, and the like. The printing device 1 according to this preferred embodiment can record characters having different colors (for example, two colors including black and red) on the printer tape 2.

The printing device 1 mainly includes a housing 4, and a tape cassette 5, a thermal head 6, a platen roller 7, and a control board 8 which are accommodated inside the housing 4.

The housing 4 may be a box-shaped member formed by, for example, a plastic case. An outlet 9 for taking out the printer tape 2 after printing is formed on an outer wall of the housing 4. A cutter (not illustrated) may be provided in the vicinity of the outlet 9. Cutting is performed using the cutter, and thereby the printer tape 2 can be separated into labels having a size for each usage unit and taken out.

The tape cassette 5 may be a removable cartridge with respect to the housing 4. The tape cassette 5 may accommodate a printer tape roll 10 (in other words, may be referred to as a label tape roll), a supply roller 11, an ink ribbon roll 12, an ink ribbon peeling member 13, and an ink ribbon winding roll 14 in this order from an upstream side to a downstream side in a tape feeding direction D1 (a direction from right to left in FIG. 1). In this preferred embodiment, the printer tape roll 10 and the ink ribbon roll 12 are types used in a state of being accommodated in the tape cassette 5, but may be, for example, types used by being directly attached to the printing device 1.

The printer tape roll 10 is manufactured by winding the printer tape 2 in a cylindrical shape, and is rotatably held by the tape cassette 5, for example. A tape drive shaft 16 provided in the housing 4 is inserted into the supply roller 11. A rotative force R1 generated by driving the tape drive shaft 16 is transmitted to the supply roller 11, and the supply roller 11 is rotated.

The ink ribbon roll 12 is manufactured by winding the ink ribbon 3 in a cylindrical shape, and is rotatably held by, for example, the tape cassette 5. A ribbon drive shaft 18 provided in the housing 4 is inserted into the ink ribbon winding roll 14. A rotative force R2 generated by driving the ribbon drive shaft 18 is transmitted to the ink ribbon winding roll 14, and the ink ribbon winding roll 14 is rotated.

The ink ribbon peeling member 13 may be a guide member that changes a feeding direction D2 of the ink ribbon 3. The ink ribbon peeling member 13 may have a shape which can abut the ink ribbon 3 being transported, for example, a roller shape, or a blade shape. A part of the ink ribbon 3 is thermocompression-bonded to the printer tape 2 by the thermal head 6, and is transported together with the printer tape 2 toward the outlet 9. The ink ribbon peeling member 13 abuts the ink ribbon 3 in the middle of transport and changes the feeding direction D2 of the ink ribbon 3 to a steep angle with respect to the feeding direction D1 of the printer tape 2. Consequently, the printer tape 2 and the ink ribbon 3 are separated from each other, and the ink ribbon 3 is peeled from the printer tape 2.

The thermal head 6 is located between the ink ribbon peeling member 13 and both the printer tape roll 10 and the ink ribbon roll 12 in the feeding direction D1 of the printer tape 2. The thermal head 6 includes a substrate 19 and a heating body 20 (for example, a heating resistor or the like) formed on the substrate 19. Joule heat generated by energization to the heating body 20 is used for thermal transfer of ink of the ink ribbon 3.

For example, a platen drive shaft 21 provided in the housing 4 is inserted into the platen roller 7. A rotative force R3 generated by driving the platen drive shaft 21 is transmitted to the platen roller 7, and the platen roller 7 is rotated. The control board 8 is an electronic instrument that executes electrical control of the printing device 1, and is installed inside the housing 4.

### [Electrical Configuration of Printing Device 1]

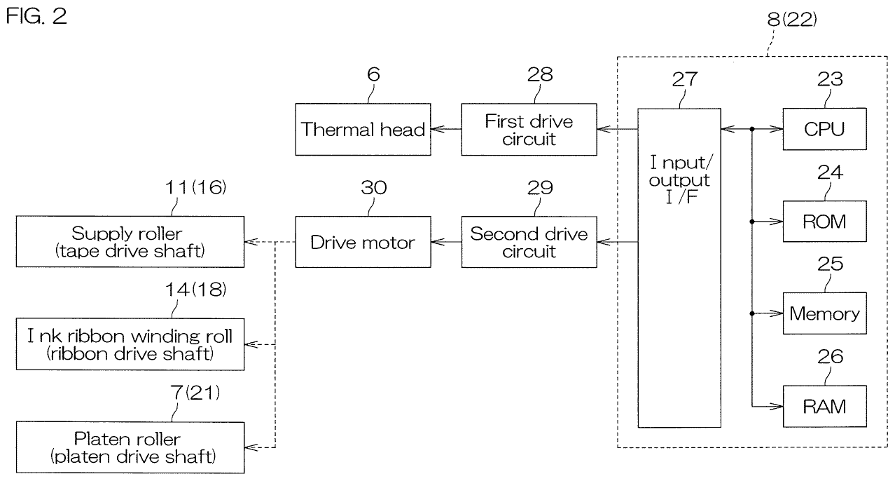

FIG. 2 is a block diagram illustrating an electrical configuration of the printing device 1.

With reference to FIG. 2, a control circuit 22 is provided on the control board 8 of the printing device 1. The control circuit 22 may include a CPU 23, a ROM 24, a memory 25, a RAM 26, and an input/output I/F 27 (interface). These elements are electrically connected through, for example, a data bus (not illustrated).

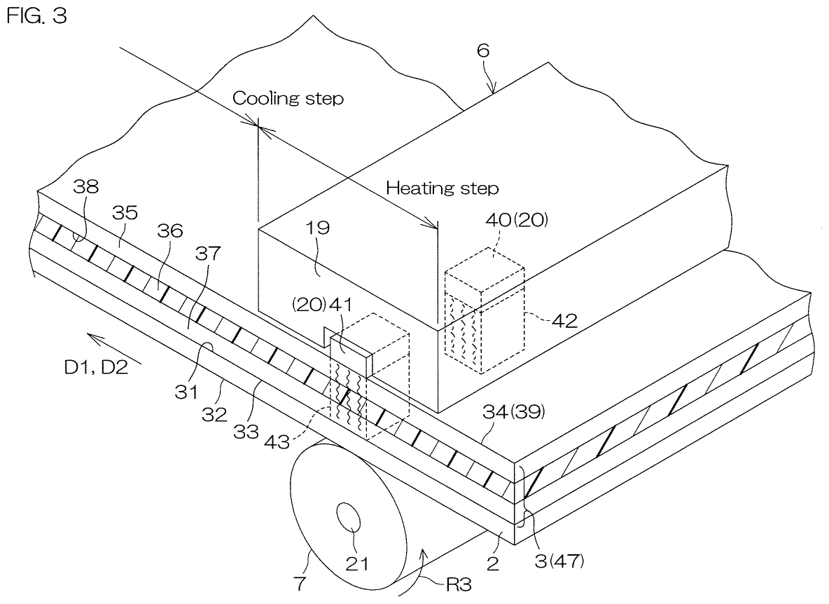

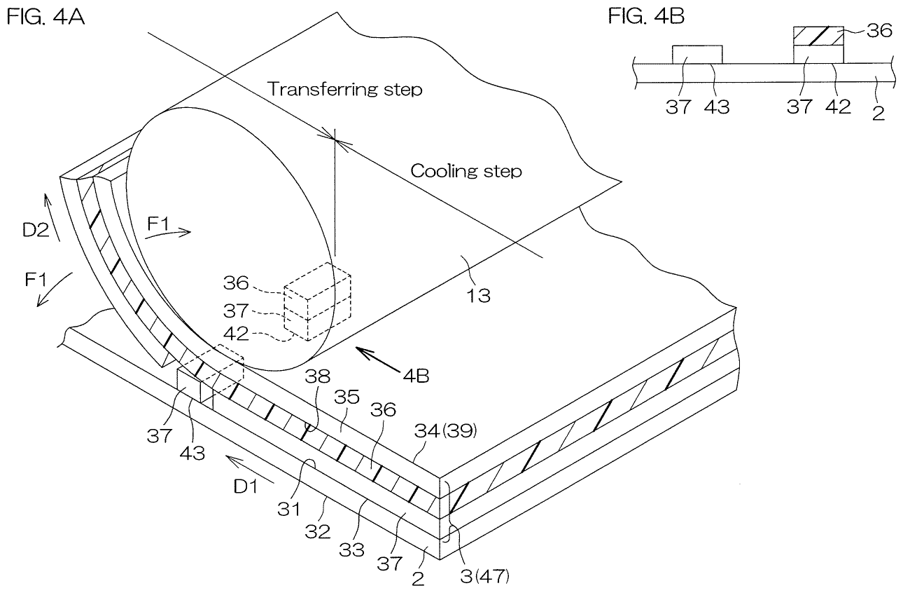

The ROM 24 stores various programs (for example, a control program or the like for executing steps illustrated in FIGS. 3 and 4A and 4B) for driving the printing device 1. The CPU 23 executes signal processing according to a program stored in the ROM 24 while using the temporary storage function of the RAM 26 and controls the printing device 1 as a whole. The memory 25 may be configured of, for example, a part of a storage region of the ROM 24. In the memory 25, a table for displaying a remaining amount (consumption amount) of the ink ribbon 3 on a display portion (not illustrated) of the housing 4 may be stored in advance.

A first drive circuit 28 and a second drive circuit 29 are electrically connected to the input/output I/F 27. The first drive circuit 28 executes energization control of the heating body 20 of the thermal head 6. The second drive circuit 29 executes drive control of outputting a drive pulse to a drive motor 30 that rotationally drives the supply roller 11, the ink ribbon winding roll 14, and the platen roller 7.

### [Flow of Printing Step by Printing Device 1]

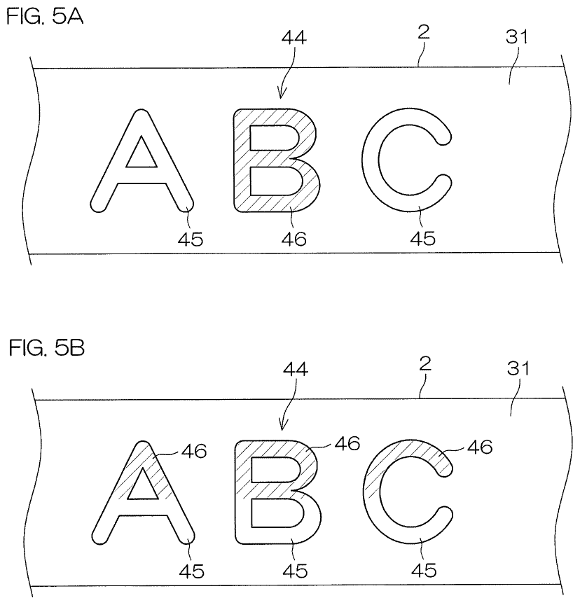

FIG. 3 is a schematic view illustrating a heating step and a cooling step of the printing device 1. FIGS. 4A and 4B are schematic views illustrating the cooling step and a transferring step of the printing device 1. FIG. 4B is an enlarged view of a main part when a transfer pattern is viewed from a direction of an arrow 4B in FIG. 4A. FIGS. 5A and 5B are views illustrating an example of a printing pattern 44 by the printing device 1. A printing step executed by the printing device 1 will be specifically described with reference to FIGS. 1 and 3 to 5A and 5B.

In order to print characters on the printer tape 2, the printer tape 2 is unrolled from the printer tape roll 10 by rotationally driving the supply roller 11, and the ink ribbon 3 is unrolled from the ink ribbon roll 12 by rotationally driving the ink ribbon winding roll 14. Consequently, as illustrated in FIGS. 1 and 3, the printer tape 2 and the ink ribbon 3 are transported toward the downstream side in a state of overlapping each other. Regarding the printer tape 2, a surface on the ink ribbon 3 side is a printing surface 31 (front surface), and a surface on the opposite side thereof is a back surface 32. Regarding the ink ribbon 3, a surface on the printer tape 2 side is an adhesive surface 33 (front surface), and a surface on the opposite side thereof is a back surface 34.

With reference to FIG. 3, the ink ribbon 3 includes a base material layer 35, a first ink layer 36 as an example of a first thermal transfer layer, and a second ink layer 37 as an example of a second thermal transfer layer. The first ink layer 36 and the second ink layer 37 are layered in this order on the front surface 38 as an example of a first surface of the base material layer 35. A surface on the opposite side to the front surface 38 of the base material layer 35 is a back surface 39 (the back surface 34 of the ink ribbon 3). The first ink layer 36 and the second ink layer 37 contain colorants having different colors. For example, the first ink layer 36 may contain a black colorant as an example of first ink, and the second ink layer 37 may contain a red colorant as an example of second ink.

The ink ribbon 3 is transported toward the thermal head 6 in a state in which the second ink layer 37 and the printer tape 2 are in contact with each other. In the thermal head 6, the heating step is executed as illustrated in FIG. 3. Specifically, the heating body 20 that generates heat due to energization is pressed against the ink ribbon 3, and thereby the heat is transmitted to the first ink layer 36 and the second ink layer 37 through the base material layer 35. A layered body of the ink ribbon 3 and the printer tape 2 is sandwiched between the thermal head 6 and the platen roller 7, and thereby the layered body is transported to the downstream side while being heated by the thermal head 6.

The heating body 20 may be controlled to have the same temperature as a whole, or may be controlled partially to have different temperatures. For example, as illustrated in FIG. 3, a first portion 40 of the heating body 20 may be controlled to have a relatively low first heating temperature, and a second portion 41 of the heating body 20 may be controlled at a second heating temperature higher than the first heating temperature. Consequently, the ink ribbon 3 may include a first portion 42 heated at the first heating temperature and a second portion 43 heated at the second heating temperature. In the first portion 42 and the second portion 43 of the ink ribbon 3, at least a part or all of the first ink layer 36 and the second ink layer 37 is melted or softened, and comes into close contact with the printer tape 2.

With reference to FIGS. 3, 4A, and 4B, the cooling step is executed in a zone between the thermal head 6 and the ink ribbon peeling member 13. Specifically, the ink ribbon 3 thermocompression-bonded to the printer tape 2 in the heating step is naturally cooled in a zone from the thermal head 6 to the ink ribbon peeling member 13, and the temperature decreases toward a use environmental temperature of the printing device 1.

Thereafter, as illustrated in FIGS. 4A and 4B, an external force F1 is applied to the base material layer 35 and the second ink layer 37 in a direction in which the layers are separated from each other, by causing the ink ribbon peeling member 13 to selectively change only the feeding direction D2 of the ink ribbon 3. Consequently, the printer tape 2 and the ink ribbon 3 are separated from each other, and the ink ribbon 3 is wound around the ink ribbon winding roll 14. At this time, in the ink ribbon 3, the first portion 42 and the second portion 43 heated by the thermal head 6 selectively remain on the printer tape 2, and thereby the transferring step is executed. For example, in the first portion 42, peeling may occur between the base material layer 35 and a layered body including the first ink layer 36 and the second ink layer 37, and the layered body may be transferred. On the other hand, in the second portion 43, peeling may occur between the first ink layer 36 and the second ink layer 37, and the second ink layer 37 may be selectively transferred.

Consequently, the printing pattern 44 having different colors (for example, two colors including black and red) is formed on the printer tape 2. For example, as illustrated in FIG. 5A, the printing pattern 44 may have a different color for each independent character. In FIG. 5A, when viewed from the printing surface 31 side of the printer tape 2, a red pattern 45 based on the second ink layer 37 may be visually recognized on the outermost surfaces of alphabets “A” and “C,” and a black pattern 46 based on the first ink layer 36 may be visually recognized on the outermost surface of “B.” On the other hand, as illustrated in FIG. 5B, in the printing pattern 44, both the red pattern 45 and the black pattern 46 may be visually recognized for each portion of the characters.

After the ink ribbon 3 is transferred, the printer tape 2 on which the characters are recorded is taken out from the outlet 9 of the printing device 1. Through the steps described above, the printed printer tape 2 can be obtained.

### [Example of Challenge in Two-Color Printing]

In the thermal transfer printer (printing device 1), after the ink ribbon 3 is heated by the thermal head 6 according to a pattern of recording information, the ink ribbon 3 is peeled from the printer tape 2. Consequently, the ink layers 36 and 37 are selectively melted or softened according to a heating pattern to be peeled from the base material layer 35 and transferred to the printing surface 31 of the printer tape 2, and characters are recorded on the printing surface 31. Thermal transfer printing of two colors as described above is also disclosed in Patent Literatures 1 and 2 described above, but there are the following challenges.

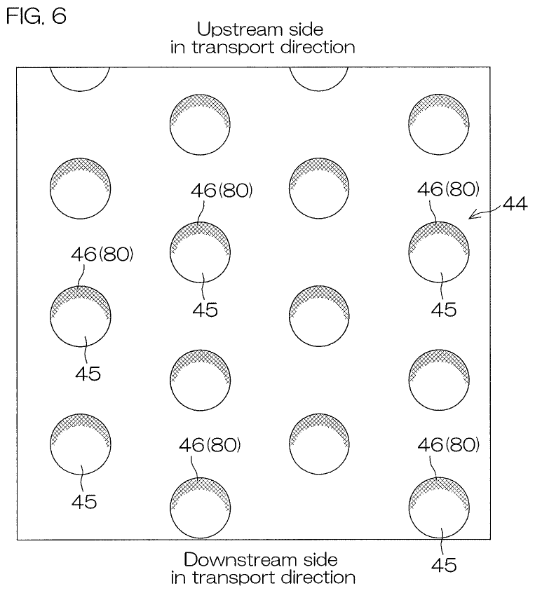

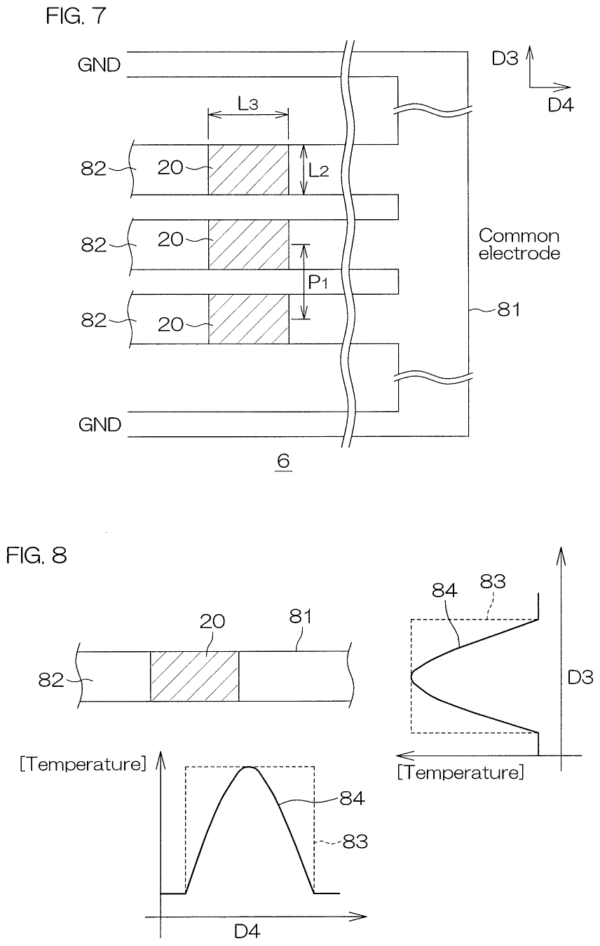

For example, FIG. 6 illustrates a printing pattern 44 of the ink ribbon in which black is transferred at the time of low-temperature heating and red is transferred at the time of high-temperature heating. For example, a fringe may be produced when only one color pattern of the two color patterns is selectively transferred. For example, with reference to FIG. 6, in the red patterns 45 arranged to form polka dots at intervals from each other, the black patterns 46 may be selectively transferred as fringes 80 at circumferential edge portions of the patterns. This type of fringe 80 is considered to be produced due to a fact that a temperature distribution is formed in a surface of the ink ribbon 3, and for example, the circumferential edge portion of the pattern does not reach a reaching temperature suitable for transferring the red pattern 45. The temperature distribution in the ink ribbon 3 is formed due to a temperature distribution in the heating body 20 of the thermal head 6. Hereinafter, an appearing principle of the fringe 80 will be described in detail with reference to FIGS. 7 to 11.

FIG. 7 is a view illustrating a circuit pattern of the heating body 20 of the thermal head 6 in FIG. 3. FIG. 8 is a diagram for illustrating a temperature distribution in the heating body 20 in FIG. 7. In FIGS. 7 and 8, the heating body 20 is hatched for the sake of clarity.

A more detailed structure of the thermal head 6 and the temperature distribution in the heating body 20 will be described with reference to FIGS. 7 and 8. First, with reference to FIG. 7, in the thermal head 6, a plurality of heating bodies 20 are regularly arranged at predetermined pitches P₁. For example, the plurality of heating bodies 20 are arranged in a vertical column at a right angle to the feeding direction D1 of the tape. The plurality of heating bodies 20 may be located in rows in the vertical and horizontal directions.

In this preferred embodiment, each heating body 20 has a rectangular shape. A length L₂ of each heating body 20 in a main scanning direction D3 may be, for example, 15 μm or longer and 300 μm or shorter. A length L₃ of each heating body 20 in a sub-scanning direction D4 may be longer than the length L₂ in the main scanning direction D3. The sub-scanning direction D4 is a direction orthogonal to the main scanning direction D3 and may be the feeding direction D1 of the printer tape 2. The predetermined pitch P₁ is, for example, a center-to-center distance of two heating bodies 20 adjacent to each other. The predetermined pitch P₁ may be, for example, 84.7 μm (300 dpi).

One terminal of each of the plurality of heating bodies 20 may be connected to a common electrode 81 (for example, GND potential) common to all the heating bodies 20, and the other terminals may be connected to electrically independent individual electrodes 82, respectively. The first drive circuit 28 controls heating temperatures of the heating bodies 20 by adjusting electric power to be supplied to the individual electrodes 82 and the energization times.

With reference to FIG. 8, a temperature distribution diagram below the heating body 20 represents a temperature distribution of the heating body 20 in a direction along the sub-scanning direction D4, and a temperature distribution diagram on the right side of the heating body 20 represents a temperature distribution of the heating body 20 in a direction along the main scanning direction D3. When electric power (energy) is supplied to the heating bodies 20, the electric energy is converted into thermal energy, and the heating bodies 20 generate heat. A temperature rise value of the heating body 20 due to heat generation can be obtained by, for example, the following Expression (1).

T1=Q/C+T0 (1)

In Expression (1), T1 represents a heating body heating temperature, T0 represents an ambient temperature, Q represents applied energy, and C represents heat capacity of the heating body 20 (depending on shapes and materials of the thermal head 6 and the heating body 20).

In a case where the applied energy Q is applied to the entire hatched portion of the heating body 20, a value of the heating body heating temperature T1 macroscopically tends to have a temperature distribution shape as represented by a broken line 83 according to Expression (1). However, since the heat flows from a side having a higher temperature to a side having a lower temperature, the heat escapes toward the periphery of the heating body 20 to which the applied energy Q is not applied, that is, toward the ambient temperature TO which is a low temperature. Hence, as represented by a solid line 84, a microscopic temperature distribution has a mountain-shaped temperature distribution shape in which a temperature is higher toward the central portion and lower toward the circumferential edge portion from the central portion. In short, this is because heat is less likely to escape at the central portion of the heating body 20, while heat is likely to escape at the circumferential edge portion.

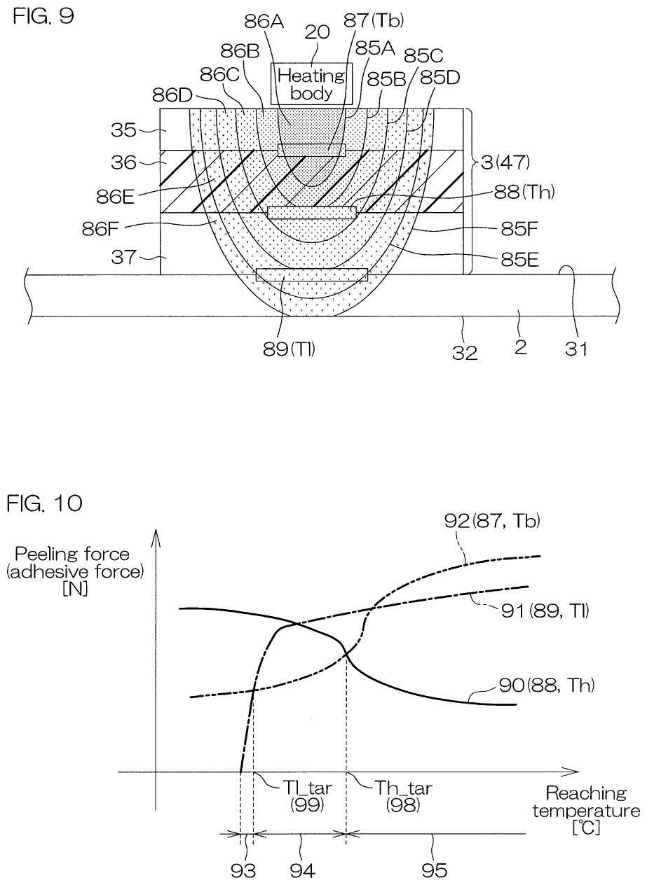

FIG. 9 is a diagram for illustrating a manner of heat transfer from the thermal head 6 to the ink ribbon 3.

With reference to FIG. 9, heat from each heating body 20 in FIG. 8 is transmitted to the inside of the ink ribbon 3 from the base material layer 35 toward the first ink layer 36 and the second ink layer 37 in this order. In FIG. 9, the manner of heat transfer from the heating body 20 to the inside of the ink ribbon 3 is represented by semi-elliptical temperature curves 85A to 85F. The temperature curves 85A to 85F are the first temperature curve 85A, the second temperature curve 85B, the third temperature curve 85C, the fourth temperature curve 85D, the fifth temperature curve 85E, and the sixth temperature curve 85F in the order of the closest one to the remotest on from the heating body 20. Regions surrounded by the temperature curves 85A to 85F are a first temperature region 86A, a second temperature region 86B, a third temperature region 86C, a fourth temperature region 86D, a fifth temperature region 86E, and a sixth temperature region 86F, respectively. At the time of performing heating by the heating body 20, the reaching temperatures of the temperature regions 86A to 86F have a relation of 86A>86B>86C>86D>86E>86F.

Hence, at the time of performing heating, a degree relationship between the reaching temperatures is formed in a thickness direction of the ink ribbon 3. For example, when comparing a reaching temperature Tb (T_{base}) of a first boundary portion 87 between the base material layer 35 and the first ink layer 36, a reaching temperature Th (T_{high}) of a second boundary portion 88 between the first ink layer 36 and the second ink layer 37, and a reaching temperature Tl (T_{low}) of a third boundary portion 89 between the second ink layer 37 and the printer tape 2, there is a degree relationship of Tb>Th>Tl. In FIG. 9, for the sake of clarity, portions of the boundary portions of the layers of the ink ribbon 3 immediately below the heating body 20 are conceptually illustrated as the first boundary portion 87, the second boundary portion 88, and the third boundary portion 89 which all have a rectangular shape.

Further, in an in-plane direction (direction orthogonal to the thickness direction) of the ink ribbon 3, the reaching temperatures Tb, Th, and Tl are not uniform and have a degree relationship (temperature distribution). For example, in the second boundary portion 88 (between the first ink layer 36 and the second ink layer 37), a central portion thereof is the second temperature region 86B, but a circumferential edge portion thereof is the third temperature region 86C and has a temperature lower than that of the central portion. Such a temperature distribution in the in-plane direction of each of the boundary portions 87 to 89 is related to the generation of the fringe 80.

FIG. 10 is a graph illustrating a relationship between a reached heating temperature and a peeling force (adhesive force) at a plurality of layer boundaries of the ink ribbon 3.

Prior to the description of a relation between the temperature distribution in the in-plane direction of each of the boundary portions 87 to 89 and the appearance of the fringe 80, a relation between the reaching temperatures Tb, Th, and Tl of the boundary portions 87 to 89 of the layers of the ink ribbon 3 and the peeling forces (adhesive forces) of the boundary portions 87 to 89 will be described with reference to FIG. 10.

With reference to FIG. 10, the horizontal axis in FIG. 10 represents the reaching temperatures of the boundary portions 87 to 89 of the layers of the ink ribbon 3, and the vertical axis in FIG. 10 represents the forces (peeling forces) required for peeling the boundary portions 87 to 89 of the layers of the ink ribbon 3. A solid line 90 in FIG. 10 represents a relationship between the reaching temperature Th and the peeling force in the second boundary portion 88 (between the first ink layer 36 and the second ink layer 37), a dash-dotted line 91 in FIG. 10 represents a relationship between the reaching temperature Tl and the peeling force in the third boundary portion 89 (between the second ink layer 37 and the printer tape 2), and a dash-double-dot line 92 in FIG. 10 represents a relationship between the reaching temperature Tb and the peeling force in the first boundary portion 87 (between the base material layer 35 and the first ink layer 36).

As illustrated in FIG. 10, a degree relationship of the peeling forces in the boundary portions 87 to 89 is not constant and changes depending on changes in the reaching temperatures Tb, Th, and Tl of the boundary portions 87 to 89. For example, the horizontal axis in FIG. 10 may be mainly divided into three zones according to the degrees of the reaching temperatures Tb, Th, and Tl of the boundary portions 87 to 89. The three zones include a first zone 93, a second zone 94, and a third zone 95.

The first zone 93 is a zone with the lowest ranges of the reaching temperatures Tb, Th, and Tl of the boundary portions 87 to 89. A degree relationship of the peeling forces in the boundary portions 87 to 89 in the first zone 93 is the third boundary portion 89<the first boundary portion 87<the second boundary portion 88. Since the peeling force of the third boundary portion 89 is substantially 0 (zero), the ink ribbon 3 does not adhere to the printer tape 2. That is, the first zone 93 may be in an initial state before energy application by the thermal head 6 (a state before the thermal transfer).

In the second zone 94, the ranges of the reaching temperatures Tb, Th, and Tl of the boundary portions 87 to 89 are between the first zone 93 and the third zone 95. A degree relationship of the peeling forces in the boundary portions 87 to 89 in the second zone 94 is the first boundary portion 87<the second boundary portion 88<the third boundary portion 89, or the first boundary portion 87<the third boundary portion 89<the second boundary portion 88. Hence, the second ink layer 37 adheres to the printer tape 2 through the third boundary portion 89, and an adhesion state between the first ink layer 36 and the second ink layer 37 is sufficiently maintained through the second boundary portion 88. On the other hand, the lowest adhesive force is generated between the base material layer 35 and the first ink layer 36 through the first boundary portion 87. Therefore, when the external force F1 (see FIGS. 4A and 4B) is applied to the ink ribbon 3 in the second zone 94, peeling occurs at the first boundary portion 87 having the weakest adhesive force. Consequently, the entire ink ribbon 3, that is, the first ink layer 36 and the second ink layer 37 are thermally transferred integrally to the printer tape 2. Therefore, the characters recorded on the printer tape 2 have, for example, a color tone of the first ink layer 36 positioned on the outermost layer after transfer, for example, black.

The third zone 95 is a zone with the highest ranges of the reaching temperatures Tb, Th, and Tl of the boundary portions 87 to 89. A degree relationship of the peeling forces in the boundary portions 87 to 89 in the third zone 95 is the second boundary portion 88<the third boundary portion 89<the first boundary portion 87, or the second boundary portion 88<the first boundary portion 87<the third boundary portion 89. Hence, the second ink layer 37 adheres to the printer tape 2 through the third boundary portion 89, and adhesion between the base material layer 35 and the first ink layer 36 is sufficiently maintained through the first boundary portion 87. On the other hand, the lowest adhesive force is generated between the first ink layer 36 and the second ink layer 37 through the second boundary portion 88. Therefore, when the external force F1 (see FIGS. 4A and 4B) is applied to the ink ribbon 3 in the third zone 95, peeling occurs at the second boundary portion 88 having the weakest adhesive force. Consequently, so-called reverse transfer in which the first ink layer 36 remains on the base material layer 35 side is performed, while only the second ink layer 37 is thermally transferred selectively to the printer tape 2. Hence, the character recorded on the printer tape 2 have the color tone of the second ink layer 37, for example, red.

As described above, it can be found that, when the external force F1 is applied to the ink ribbon 3, a boundary portion which becomes a peeling position of the three boundary portions 87 to 89 is related to the reaching temperatures of the boundary portions 87 to 89. For example, at the time of low-temperature heating (the second zone 94) when low energy is applied to the heating body 20, the peeling position is present between the base material layer 35 and the first ink layer 36, and a thermal transfer color becomes black. On the other hand, at the time of high-temperature heating (the third zone 95) when high energy is applied to the heating body 20, the peeling position is present between the first ink layer 36 and the second ink layer 37, and a thermal transfer color becomes red.

However, in order to accurately transfer the characters having two colors without the fringes 80, it is limited to a case where the reaching temperatures Th and Tl of the second boundary portion 88 and the third boundary portion 89 are uniform over the entire boundary portions in the in-plane direction and satisfy a temperature condition suitable for the transfer. As illustrated in FIG. 9, normally, the temperature distribution is formed in the in-plane direction of the ink ribbon 3, thus, causing the fringes 80 to appear.

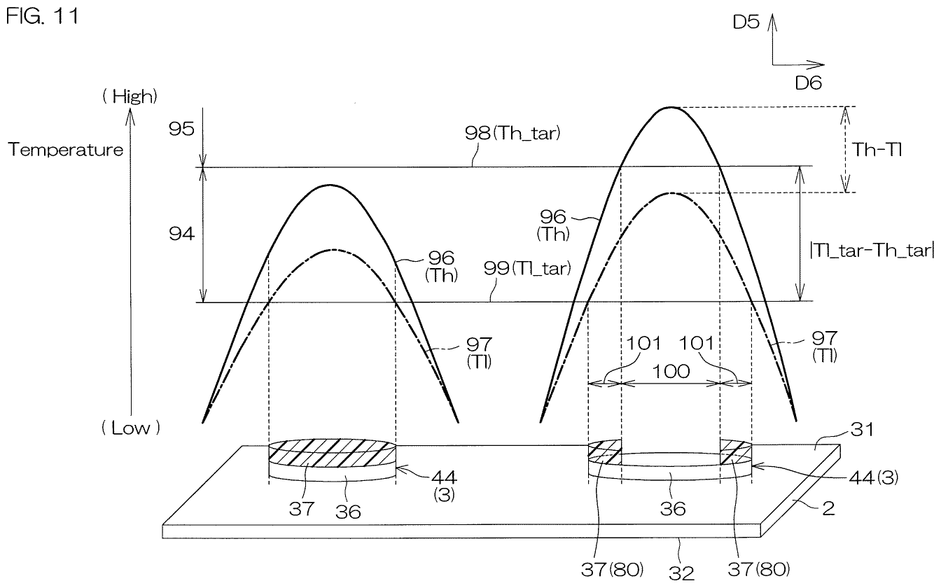

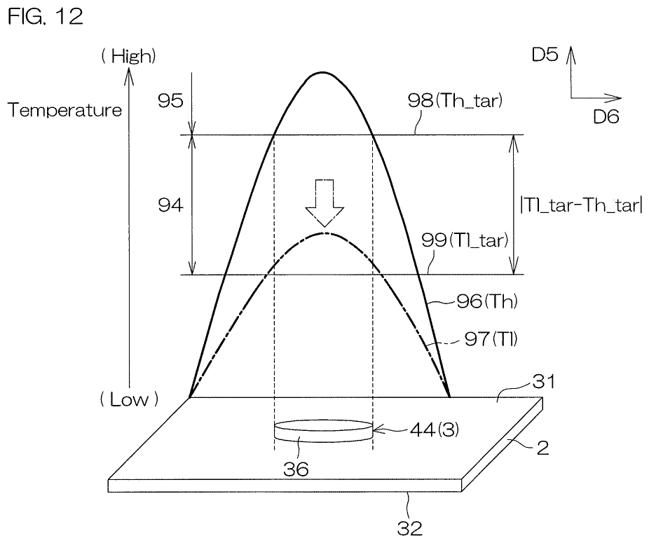

FIG. 11 is a diagram for illustrating an appearing principle of the fringe 80. FIG. 12 is a diagram for illustrating a countermeasure against the fringe 80. In FIG. 11, the thickness direction of the ink ribbon 3 is described as a direction D5, and the in-plane direction of the ink ribbon 3 orthogonal to the thickness direction D5 is described as D6.

With reference to FIG. 11, a solid line drawn in a mountain shape represents a first temperature distribution curve 96 of the reaching temperature Th of the outermost surface of the ink ribbon 3 remaining on the base material layer 35 side without being transferred at the time of transfer of the second ink layer 37. Here, the highest temperature is observed at the apex thereof, and the closer a portion is to the bottom, the lower the temperature. A dash-dotted line drawn in a mountain shape represents a second temperature distribution curve 97 of the reaching temperature Tl of the outermost surface (that is, the third boundary portion 89) of the ink ribbon 3, and the highest temperature is observed at the apex thereof, and the closer a portion is to the bottom, the lower the temperature. Two straight lines crossing the first temperature distribution curve 96 and the second temperature distribution curve 97 represent, in order from the top, a high temperature side boundary condition 98 (corresponding to Th-tar in FIG. 10) suitable for red transfer and a low temperature side boundary condition 99 (corresponding to Tl-tar in FIG. 10) suitable for black transfer, respectively.

With reference to the left side in FIG. 11 (at the time of low-temperature heating), both the first temperature distribution curve 96 and the second temperature distribution curve 97 are present between the low temperature side boundary condition 99 and the high temperature side boundary condition 98 (the second zone 94) over the entire printing pattern 44 in the in-plane direction D6. With reference to FIG. 10, under this condition, since the peeling force of the first boundary portion 87 is the smallest at any position of the printing pattern 44 in the in-plane direction D6, peeling occurs in the first boundary portion 87 over the entire printing pattern 44 in the in-plane direction D6. Hence, it is possible to transfer black without the fringes 80.

With reference to the right side of FIG. 11, the second temperature distribution curve 97 is present between the low temperature side boundary condition 99 and the high temperature side boundary condition 98 (the second zone 94). On the other hand, the first temperature distribution curve 96 exceeds the high temperature side boundary condition 98 (the third zone 95) in a central portion 100 that is likely to have a relatively high temperature, and is present between the low temperature side boundary condition 99 and the high temperature side boundary condition 98 (the second zone 94) in a circumferential edge portion 101 that is likely to have a temperature lower than that of the central portion 100. In such a situation, the peeling force in the second boundary portion 88 (between the first ink layer 36 and the second ink layer 37) does not sufficiently decrease, and a degree relationship of the peeling forces at the circumferential edge portion 101 is the degree relationship illustrated in the second zone 94 in FIG. 10. That is, since the peeling force becomes the smallest in the first boundary portion 87, peeling occurs in the first boundary portion 87. Consequently, the fringes 80 selectively appear in the circumferential edge portion 101 of the printing pattern 44.

In this respect, the inventors of the present application have found that, in order to prevent such fringes 80 from appearing, the fringes 80 can be prevented by making a temperature difference between the reaching temperature Th of the second boundary portion 88 and the reaching temperature Tl of the third boundary portion 89 close to a temperature difference between the high temperature side boundary condition (Th_tar) and the low temperature side boundary condition (Tl_tar) as illustrated in FIG. 12. That is, it has been found that the fringe 80 can be prevented by making |Th−Tl| close to |(Tl_tar)−(Th_tar)|. More specifically, the amount of heat transfer to the third boundary portion 89 may be reduced by increasing a heat transfer distance between the second boundary portion 88 and the third boundary portion 89 by adjusting the thickness of the second ink layer 37 to be increased. Consequently, the apex of the second temperature distribution curve 97 is relatively lowered in the second boundary portion 88 as illustrated in FIG. 12, and thus, a relationship approximate to |Th−Tl|=|(Tl_tar)−(Th_tar)| is obtained.

### [Specific Configuration of Thermal Transfer Recording Medium]

Next, an example of a configuration of the thermal transfer recording medium 47 (ink ribbon) that can prevent the fringe 80 from appearing will be described.

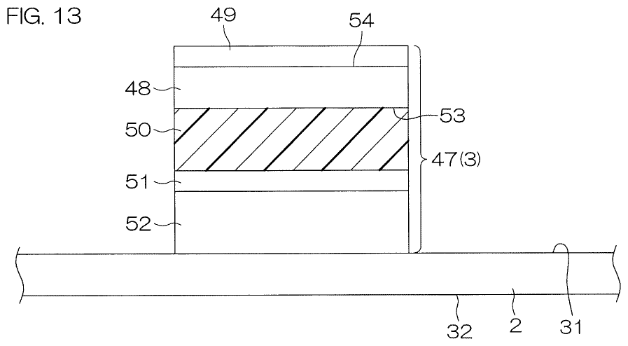

FIG. 13 is a schematic cross-sectional view illustrating a layer configuration of the thermal transfer recording medium 47 according to a preferred embodiment of the present disclosure. FIG. 13 illustrates the thermal transfer recording medium 47 in a state of adhering to the printer tape 2 as an example of the printing medium.

The thermal transfer recording medium 47 may be used as the ink ribbon 3 in the printing device 1 and the printing step illustrated in FIGS. 1 to 4A and 4B. The thermal transfer recording medium 47 includes a base material layer 48, a back surface layer 49, a first thermal transfer layer 50, a middle layer 51, and a second thermal transfer layer 52. The first thermal transfer layer 50, the middle layer 51, and the second thermal transfer layer 52 are layered in this order on a front surface 53 as an example of a first surface of the base material layer 48. A surface of the base material layer 48 opposite to the front surface 53 may be a back surface 54. The back surface layer 49 is layered on the back surface 54 of the base material layer 48. The first thermal transfer layer 50 and the second thermal transfer layer 52 may be referred to as a first ink layer and a second ink layer, respectively.

The thermal transfer recording medium 47 of the present disclosure is characterized by including the base material layer 48, and the first thermal transfer layer 50, the middle layer 51, and the second thermal transfer layer 52 which are layered in this order in direct contact with each other on the front surface 53 of the base material layer 48. The middle layer 51 includes a thermoplastic elastomer as a binder.

For example, the energy amount applied to the thermal head 6 (see FIGS. 1 and 3) may be set to be low such that thermal transfer may be performed at a relatively low temperature in the thermal transfer recording medium 47. In this case, the first thermal transfer layer 50 is softened, and the adhesion to the base material layer 48 decreases. On the other hand, the second thermal transfer layer 52 is softened, and the adhesion to the printing surface 31 of the printer tape 2 is produced. In addition, affinity between the middle layer 51 and both the thermal transfer layers 50 and 52 is enhanced, and the adhesion of both the thermal transfer layers 50 and 52 to the middle layer 51 is improved. Further, the middle layer 51 including the thermoplastic elastomer has a relatively high melt viscosity as compared with the wax or the like forming the peeling layer as in Patent Literature 1. The middle layer 51 maintains the adhesion to the first thermal transfer layer 50 and the second thermal transfer layer 52 due to rubber-like elasticity of the middle layer. As a result, all of the thermal transfer layers, that is, the first thermal transfer layer 50, the middle layer 51, and the second thermal transfer layer 52, are thermally transferred integrally to the printing surface 31 of the printer tape 2. A character recorded on the printing surface 31 of the printer tape 2 has a color tone of the first thermal transfer layer 50 located on the outermost layer after transfer, for example, black.

On the other hand, the energy amount applied to the thermal head 6 may be set to be high such that the thermal transfer recording medium 47 may be thermally transferred at a higher temperature. In this case, the first thermal transfer layer 50 is further softened to increase the adhesion to the base material layer 48, and the second thermal transfer layer 52 has the adhesion to the printing surface 31 of the printer tape 2. In addition, the adhesion of the first thermal transfer layer 50 to the middle layer 51 increases, and exceeds the adhesion between the second thermal transfer layer 52 and the middle layer 51. During the thermal transfer, only the second thermal transfer layer 52 is thermally transferred to the printing surface 31 of the printer tape 2 while reverse transfer in which the first thermal transfer layer 50 and the middle layer 51 remain on the base material layer 48 side occurs. Hence, the character recorded on the printing surface 31 of the printer tape 2 have the color tone of the second thermal transfer layer 52, for example, red. As a result, for example, a pattern having two colors including black and red can be recorded using the general-purpose thermal transfer printer for two-color recording.

In addition, since the thermoplastic elastomer included in the middle layer 51 has a melt viscosity higher than that of the wax or the like as described above, the low-temperature transfer range in which both the thermal transfer layers 50 and 52 can be integrally transferred can be widened to a high temperature side to narrow the dusky transfer range. Furthermore, characteristics such as the rubber-like elasticity and the adhesion of the middle layer 51 including the thermoplastic elastomer having the high melt viscosity have temperature dependency lower than that of both the thermal transfer layers 50 and 52 and the peeling layer. Therefore, even if the thermal transfer recording is continuously performed and the temperature of the thermal head 6 gradually rises, it is also possible to prevent the character from having a dusky color tone.

Hence, according to the present disclosure, color tones are not likely to become dusky and can be clearly separated into two colors even in the continuous thermal transfer recording, and a character can be recorded with excellent sharpness without extra peeling, by using a general-purpose thermal transfer printer for two-color recording.

Hereinafter, specific compositions, physical properties, and the like of the base material layer 48, the back surface layer 49, the first thermal transfer layer 50, the middle layer 51, and the second thermal transfer layer 52 included in the thermal transfer recording medium 47 will be described in detail.

### (1) Base Material Layer 48

Examples of the base material layer 48 include a film of a resin such as polysulfone, polystyrene, polyamide, polyimide, polycarbonate, polypropylene, polyester, or triacetate, condenser paper, tissue paper such as glassine paper, cellophane, and the like. Of these materials, a film of polyester such as polyethylene terephthalate (PET) or polyethylene naphthalate is preferable from the viewpoint of mechanical strength, dimensional stability, heat treatment resistance, price, or the like. A thickness of the base material layer 48 can be arbitrarily set according to, for example, specifications of a thermal transfer printer. For example, the thickness of the base material layer 48 is 1 μm or more, and preferably 2 μm or more. For example, the thickness of the base material layer 48 is 10 μm or less, and preferably 8 μm or less. For example, the thickness of the base material layer 48 is 1 μm or more and 10 μm or less, and preferably 2 μm or more and 8 μm or less.

### (2) Back Surface Layer 49

The back surface layer 49 improves heat resistance, slippage, abrasion resistance, or the like of the back surface 54 of the base material layer 48 which is brought into contact with the thermal head 6. Examples of the back surface layer 49 include a silicone resin, a fluororesin, a silicone-fluorine copolymer resin, a nitrocellulose resin, a silicone-modified urethane resin, a silicone-modified acrylic resin, and the like. The back surface layer 49 may include a lubricant, as necessary.

The back surface layer 49 can be formed, for example, by applying, on the back surface 54 of the base material layer 48, a coating material obtained by dissolving or dispersing the resin or the like in any solvent, and then drying the coating material. A thickness of the back surface layer 49 can be arbitrarily set according to, for example, specifications of a thermal transfer printer. The thickness of the back surface layer 49 can be adjusted by an application amount of the back surface layer 49.

For example, the application amount of the back surface layer 49 is 0.05 g/m² or more, and preferably 0.1 g/m² or more in terms of a solid content per unit area. For example, the application amount of the back surface layer 49 is 0.5 g/m² or less, and preferably 0.4 g/m² or less in terms of the solid content per unit area. For example, the application amount of the back surface layer 49 is 0.05 g/m² or more and 0.5 g/m² or less, and preferably 0.1 g/m² or more and 0.4 g/m² or less in terms of the solid content per unit area. A specific thickness of the back surface layer 49 is, for example, 0.05 μm or more and 0.5 μm or less, and may be preferably 0.1 μm or more and 0.4 μm or less.

### (3) First Thermal Transfer Layer 50

The first thermal transfer layer 50 can be made of, for example, any thermoplastic resin. The first thermal transfer layer 50 is preferably formed using an epoxy resin as the thermoplastic resin in consideration of improving the affinity and the adhesion to the base material layer 48 and the middle layer 51. The epoxy resin is excellent in affinity and adhesion to the thermoplastic elastomer included in the base material layer 48 and the middle layer 51 formed by a film of polyester such as PET. The first thermal transfer layer 50 can be formed using, as a thermoplastic resin, an epoxy resin in a (excluding) state in which a curing agent is not blended.

Examples of the epoxy resin include a bisphenol A epoxy resin, a bisphenol F epoxy resin, a phenol novolac epoxy resin, a cresol novolac epoxy resin, an alicyclic epoxy resin, a hydrogenated bisphenol A epoxy resin, a hydrogenated bisphenol AD epoxy resin, an aliphatic epoxy resin such as propylene glycol glycoxyl ether or pentaerythritol polyglycidyl ether, an epoxy resin obtained from aliphatic or aromatic amine and epichlorohydrin, an epoxy resin obtained from aliphatic or aromatic carboxylic acid and epichlorohydrin, a heterocyclic epoxy resin, a spirocyclic epoxy resin, an epoxy-modified resin, a brominated epoxy resin, and the like. Specific examples of the epoxy resin are not particularly limited, and include the following various epoxy resins. These epoxy resins can be used individually or in combination of two or more kinds thereof.

Examples thereof include, in the JER (registered trademark) series of epoxy resins manufactured by Mitsubishi Chemical Group, basic solid types 1001 [softening point (ring-and-ball method): 64° C., number average molecular weight Mn: about 900], 1002 [softening point (ring-and-ball method): 78° C., number average molecular weight Mn: about 1,200], 1003 [softening point (ring-and-ball method): 89° C., number average molecular weight Mn: about 1,300], 1055 [softening point (ring-and-ball method): 93° C., number average molecular weight Mn: about 1,600], 1004 [softening point (ring-and-ball method): 97° C., number average molecular weight Mn: about 1,650], 1004AF [softening point (ring-and-ball method): 97° C., number average molecular weight Mn: about 1,650], 1007 [softening point (ring-and-ball method): 128° C., number average molecular weight Mn: about 2,900], 1009 [softening point (ring-and-ball method): 144° C., number average molecular weight Mn: about 3,800], 1010 [number average molecular weight Mn: about 5,500], 1003F [softening point (ring-and-ball method): 96° C.], 1004F [softening point (ring-and-ball method): 103° C.], 1005F, 1009F [softening point (ring-and-ball method): 144° C.], 1004FS [softening point (ring-and-ball method): 100° C.], 1006FS [softening point (ring-and-ball method): 112° C.], and 1007FS [softening point (ring-and-ball method): 124° C.].

The softening point of the epoxy resin used for the first thermal transfer layer 50 is, for example, 95° C. or higher, preferably 110° C. or higher, and more preferably 125° C. or higher. When the softening point falls within this range, it is possible to prevent a high adhesive force from being generated between the first thermal transfer layer 50 and the base material layer 48 at a relatively low temperature during low-temperature transfer. Since the low-temperature transfer range of the first thermal transfer layer 50 can be sufficiently widened toward a high temperature side, it is possible to prevent the color tones from becoming dusky even in the continuous thermal transfer recording.

The first thermal transfer layer 50 may contain an adhesive in addition to the epoxy resin. The affinity and the adhesion to the base material layer 48 and the middle layer 51 can be further improved with the adhesive contained in the first heat transfer layer. Examples of the adhesive include a rubber-based adhesive, an acrylic adhesive, a silicone-based adhesive, a vinyl alkyl ether-based adhesive, a polyvinyl alcohol-based adhesive, a polyvinylpyrrolidone-based adhesive, a polyacrylamide-based adhesives, a cellulose-based adhesive, and the like.

In consideration of improving affinity and compatibility with the epoxy resin and the affinity and the adhesion to the base material layer 48 and the middle layer 51, the acrylic adhesive is preferable as the adhesive. Specific examples of the acrylic adhesive are not particularly limited, and include the following various acrylic adhesives. These acrylic adhesives can be used individually or in combination of two or more kinds thereof.

Examples thereof include, in the Oribain (registered trademark) BPS (solvent-based) series manufactured by TOYOCHEM CO., LTD., BPS 1109 (non-volatile content: 39.5 mass %), BPS 3156D (non-volatile content: 34 mass %), BPS 4429-4 (non-volatile content: 45 mass %), BPS 4849-40 (non-volatile content: 40 mass %), BPS 5160 (non-volatile content: 33 mass %), BPS 5213K (non-volatile content: 35 mass %), BPS 5215K (non-volatile content: 39 mass %), BPS 5227-1 (non-volatile content: 41.5 mass %), BPS 5296 (non-volatile content: 37 mass %), BPS 5330 (non-volatile content: 40 mass %), BPS 5375 (non-volatile content: 45 mass %), BPS 5448 (non-volatile content: 40 mass %), BPS 5513 (non-volatile content: 44.5 mass %), BPS 5565K (non-volatile content: 45 mass %), BPS 5669K (non-volatile content: 46 mass %), BPS 5762K (non-volatile content: 45.5 mass %), BPS 5896 (non-volatile content: 37 mass %), BPS 5978 (non-volatile content: 35 mass %), BPS 6074HTF (non-volatile content: 52 mass %), BPS 6080TFK (non-volatile content: 45 mass %), BPS 6130TF (non-volatile content: 45.5 mass %), BPS 6153K (non-volatile content: 25 mass %), BPS 6163 (non-volatile content: 37 mass %), BPS 6231 (non-volatile content: 56 mass %), BPS 6421 (non-volatile content: 47 mass %), BPS 6430 (non-volatile content: 33 mass %), BPS 6574 (non-volatile content: 57 mass %), BPS 8170 (non-volatile content: 36.5 mass %), and BPS HS-1 (non-volatile content: 40 mass %).

Further, Examples thereof include, of the solvent-based adhesives (peeling-type) manufactured by LION SPECIALTY CHEMICALS CO., LTD., AS-325 (solid content concentration: 45 mass %), AS-375 (solid content concentration: 45 mass %), AS-409 (solid content concentration: 45 mass %), AS-417 (solid content concentration: 45 mass %), AS-425 (solid content concentration: 45 mass %), AS-455 (solid content concentration: 45 mass %), AS-665 (solid content concentration: 40 mass %), AS-1107 (solid content concentration: 43 mass %), and AS-4005 (solid content concentration: 45 mass %).

The acrylic adhesive used in the first thermal transfer layer 50 may be used in combination with a tackifier. This is because, for example, it is possible to increase the sharpness of the first thermal transfer layer 50, prevent the extra peeling, and improve the sharpness of the character to be recorded. Examples of the tackifier include ester gum, terpene phenolic resin, rosin ester, and the like. Specific examples of the tackifier are not particularly limited, and include the following various tackifiers. These tackifiers can be used individually or in combination of two or more kinds thereof.

Examples thereof include, of the terpene phenolic resins in YS POLYSTER series manufactured by YASUHARA CHEMICAL Co., Ltd., U130 (softening point: 130±5° C.), U115 (softening point: 115±5° C.), T160 (softening point: 160±5° C.), T145 (softening point: 145±5° C.), T130 (softening point: 130±5° C.), T115 (softening point: 115±5° C.), T100 (softening point: 100±5° C.), T80 (softening point: 80±5° C.), S145 (softening point: 145±5° C.), G150 (softening point: 150±5° C.), G125 (softening point: 125±5° C.), N125 (softening point: 125±5° C.), K125 (softening point: 125±5° C.), and TH130 (softening point: 130±5° C.).

Further, examples thereof include, of the ester gums manufactured by Arakawa Chemical Industries, Ltd., AA-G [softening point (ring-and-ball method): 82 to 88° C.], AA-L [softening point (ring-and-ball method): 82 to 88° C.], AA-V [softening point (ring-and-ball method): 82 to 95° C.], 105 [softening point (ring-and-ball method): 100 to 110° C.], AT [viscosity: 20,000 to 40,000 mPa-s], H [softening point (ring-and-ball method): 68 to 75° C.], and HP [softening point (ring-and-ball method): 80° C. or higher].

Furthermore, examples thereof include, of the rosin esters in the PENSEL (registered trademark) series manufactured by Arakawa Chemical Industries, Ltd., GA-100 [softening point (ring-and-ball method): 100 to 110° C.], AZ [softening point (ring-and-ball method): 950 to 105° C.], C [softening point (ring-and-ball method): 117 to 127° C.], D-125 [softening point (ring-and-ball method): 120 to 130° C.], D-135 [softening point (ring-and-ball method): 130 to 140° C.], D-160 [softening point (ring-and-ball method): 150 to 165° C.], and KK [softening point (ring-and-ball method): 165° C. or higher].

The softening point of the tackifier used in the first thermal transfer layer 50 is, for example, 60° C. or higher, and preferably 120° C. or lower. When the softening point falls within this range, the first thermal transfer layer 50 and the middle layer 51 can be well reversely transferred to the base material layer 48 side at the time of high-temperature transfer. Since the high-temperature transfer range of the first thermal transfer layer 50 can be sufficiently widened to a low temperature side, it is possible to prevent the color tones from becoming dusky.

The first thermal transfer layer 50 may contain any colorant. As the colorant, one or more kinds of various colorants corresponding to the color tones of the first thermal transfer layer 50 can be used. For example, pigments may be used as the colorants. In consideration of improvement or the like in weather resistance of a character, the pigments are preferable as the colorants used in the first thermal transfer layer 50. For example, carbon black is preferable as a pigment for coloring the first thermal transfer layer 50 into black. Specific examples of the carbon black are not particularly limited, and include the following various carbon blacks. These carbon blacks can be used individually or in combination of two or more kinds thereof.

Examples thereof include MA77 in powder form [LFF, DBP absorption number: 68 cm³/100 g], MA7 in powder form [LFF, DBP absorption number: 66 cm³/100 g], MA7 in bead form [LFF, DBP absorption number: 65 cm³/100 g], MA8 in powder form [LFF, DBP absorption number: 57 cm³/100 g], MA8 in bead form [LFF, DBP absorption number: 51 cm³/100 g], MA11 in powder form [LFF, DBP absorption number: 64 cm³/100 g], MA100 in powder form [LFF, DBP absorption number: 100 cm³/100 g], MA100 in bead form [LFF, DBP absorption number: 95 cm³/100 g], MA100R in powder form [LFF, DBP absorption number: 100 cm³/100 g], MA100R in bead form [LFF, DBP absorption number: 95 cm³/100 g], MA100S in powder form [LFF, DBP absorption number: 100 cm³/100 g], MA230 in powder form [LFF, DBP absorption number: 113 cm³/100 g], MA220 in powder form [LFF, DBP absorption number: 93 cm³/100 g], and MA14 in powder form [LFF, DBP absorption number: 73 cm³/100 g] manufactured by Mitsubishi Chemical Group.

Further, examples thereof include #3030B (furnace method, DBP absorption number: 130 cm³/100 g), #3040B (furnace method, DBP absorption number: 114 cm³/100 g), #3050B (furnace method, DBP absorption number: 175 cm³/100 g), #3230B (furnace method, DBP absorption number: 140 cm³/100 g), #3350B (furnace method, DBP absorption number: 164 cm³/100 g), and #3400B (furnace method, DBP absorption number: 175 cm³/100 g) manufactured by Mitsubishi Chemical Group.

Furthermore, examples thereof include, in the TOKABLACK (registered trademark) series manufactured by Tokai Carbon Co., Ltd., #5500 (furnace method, DBP absorption number: 155 cm³/100 g), #4500 (furnace method, DBP absorption number: 168 cm³/100 g), #4400 (furnace method, DBP absorption number: 135 cm³/100 g), and #4300 (furnace method, DBP absorption number: 142 cm³/100 g).

Examples thereof include, in the PRINTEX (registered trademark) series manufactured by ORION ENGINEERED CARBONS, L (furnace method, DBP absorption number: 120 cm³/100 g) and L6 (furnace method, DBP absorption number: 126 cm³/100 g).

Examples thereof include, in the CONDUCTEX (registered trademark) series manufactured by Birla Carbon, 975 (furnace method, 170 cm³/100 g) and SC (furnace method, 115 cm³/100 g).

Examples thereof include, XC72 (furnace method, DBP absorption number: 174 cm³/100 g) and 9A32 (furnace method, DBP absorption number: 114 cm³/100 g) in the VULCAN (registered trademark) series manufactured by Cabot Corporation, and 3700 (furnace method, DBP absorption number: 111 cm³/100 g) in the BLACK PEARLS series manufactured by Cabot Corporation.

Examples thereof include, in the DENKA BLACK (registered trademark) series manufactured by Denka Company Limited, DENKA BLACK bead-form product (acetylene process, DBP absorption number: 160 cm³/100 g), FX-35 (acetylene process, DBP absorption number: 220 cm³/100 g), and HS-100 (acetylene process, DBP absorption number: 140 cm³/100 g).

Examples thereof include, in the KETJENBLACK (registered trademark) series manufactured by LION SPECIALTY CHEMICALS CO., LTD., EC300J (gasification process, DBP absorption number: 360 cm³/100 g) and EC600DJ (gasification process, DBP absorption number: 495 cm³/100 g).

Ratios of components in the first thermal transfer layer 50 are not particularly limited. The ratio of the acrylic adhesive with respect to 100 parts by mass of the epoxy resin is, for example, 30 parts by mass or more, and preferably 40 parts by mass or more. The ratio of the acrylic adhesive with respect to 100 parts by mass of the epoxy resin is, for example, 150 parts by mass or less, and preferably 100 parts by mass or less. The ratio of the acrylic adhesive with respect to 100 parts by mass of the epoxy resin is, for example, 30 parts by mass or more and 150 parts by mass or less, and preferably 40 parts by mass or more and 100 parts by mass or less.

The ratio of the tackifier with respect to 100 parts by mass of the epoxy resin is, for example, 3 parts by mass or more, and preferably 5 parts by mass or more. The ratio of the tackifier with respect to 100 parts by mass of the epoxy resin is, for example, 150 parts by mass or less, and preferably 100 parts by mass or less. The ratio of the tackifier with respect to 100 parts by mass of the epoxy resin is, for example, 3 parts by mass or more and 150 parts by mass or less, and preferably 5 parts by mass or more and 100 parts by mass or less.

A ratio of the colorant such as carbon black with respect to 100 parts by mass of the epoxy resin is, for example, 100 parts by mass or more, and preferably 130 parts by mass or more. The ratio of the colorant with respect to 100 parts by mass of the epoxy resin is, for example, 230 parts by mass or less, and preferably 200 parts by mass or less. The ratio of the colorant with respect to 100 parts by mass of the epoxy resin is, for example, 100 parts by mass or more and 230 parts by mass or less, and preferably 130 parts by mass or more and 200 parts by mass or less.

Note that, of the components contained in the first thermal transfer layer 50, a blending amount of a component which is supplied in a liquid form dissolved or dispersed in any solvent may be adjusted so that a ratio of an active component falls within the above range (the same being applied to the following).

The first thermal transfer layer 50 can be formed, for example, by applying, onto the front surface 53 of the base material layer 48 directly or through any release layer, a coating material obtained by dissolving or dispersing each of the above-described components in any solvent, and then drying the coating material. In the present disclosure, as illustrated in FIGS. 5A and 5B, the characters to be recorded on the printer tape 2 are color-coded. In order to perform this color-coding, it is preferable that the first thermal transfer layer 50 is directly formed on the front surface 53 of the base material layer 48 without the release layer, in consideration of adjustment of the adhesion between the first thermal transfer layer 50 and the base material layer 48 or each of other layers.

### (4) Middle Layer 51

The middle layer 51 includes a thermoplastic elastomer as described above. In particular, the middle layer 51 is preferably formed only by the thermoplastic elastomer. The thermoplastic elastomer forming the middle layer 51 preferably includes at least one of a styrene-based thermoplastic elastomer and an acetate ester-based thermoplastic elastomer.

Examples of the styrene-based thermoplastic elastomer include a styrene-butadiene-styrene block copolymer (SBS), a styrene-ethylene-butene-styrene block copolymer (SEBS), a styrene-ethylene-propylene-styrene block copolymer (SEPS), a styrene-ethylene/ethylene-propylene-styrene block copolymer (SEEPS), a styrene-isoprene-styrene block copolymer (SIS), and the like. Examples of the acetate ester-based thermoplastic elastomer include an ethylene-vinyl acetate copolymer (EVA) and the like.

A percentage styrene content in the thermoplastic elastomer included in the middle layer 51 is, for example, 10 mass % or more and 70 mass % or less, and preferably 15 mass % or more and 50 mass % or less. If the percentage styrene content is too high, the rubber-like elasticity of the middle layer 51 decreases, and there is a case where it is not possible to maintain the adhesion to the first thermal transfer layer 50 and the second thermal transfer layer 52 at the time of low-temperature transfer, or a case where the color tones of the characters become dusky. If the percentage styrene content is too low, the rubber-like elasticity of the middle layer 51 increases too high, so that it is not possible for the second thermal transfer layer 52 to be peeled off at the time of high-temperature transfer, and the colors of the character may become dusky.

The thermoplastic elastomer included in the middle layer 51 has a Melt Mass-Flow Rate (hereinafter simply abbreviated as “MFR”) of, for example, 1000 g/10 min or less, and preferably 400 g/10 min or less. The MFR may be, for example, an MFR at a temperature of 190° C. and under a load of 2.16 kg, which is determined in accordance with a measurement method defined in ISO 1133-1:2011. Hereinafter, unless otherwise specified, conditions for measuring the MFR are a temperature of 190° C. and a load of 2.16 kg.

The thermoplastic elastomer having an MFR of more than 400 g/10 min tends to have too high affinity to the second thermal transfer layer 52. Therefore, there is a case where it is not possible to peel the second thermal transfer layer 52 at the time of high-temperature transfer, and the colors of the characters become dusky. In addition, the entire thermal transfer recording medium 47, that is, the base material layer 48, the first thermal transfer layer 50, the middle layer 51, and the second thermal transfer layer 52, may be attached to the printing surface 31 of the printer tape 2. A thermoplastic elastomer having an MFR of more than 400 g/10 min has a low melt viscosity and high fluidity, and thus may fail to maintain the adhesion to the first thermal transfer layer 50 and the second thermal transfer layer 52 at the time of low-temperature transfer, or may result in dusky color tone of the characters.

In this respect, when the thermoplastic elastomer has an MFR of 400 g/10 min or less, it is possible to prevent problems that may arise when the thermoplastic elastomer having an MFR exceeding 400 g/10 min is used. Accordingly, even if the thermal transfer recording is continuously performed, the color tones do not easily become dusky and are clearly separated into two colors on the printing surface 31 of the printer tape 2, and furthermore, the characters can be recorded with excellent sharpness without extra peeling. In consideration of further improving these effects, the MFR of the thermoplastic elastomer is preferably 2.5 g/10 min or less, and particularly 2.3 g/10 min or less even within the above range.

The lower limit of the MFR is not particularly limited, and thermoplastic elastomers having a measurement result of “No Flow (not flowing)” at a temperature of 190° C. under a load of 2.16 kg can also be used. Specific examples of the thermoplastic elastomers are not particularly limited, and include the following various thermoplastic elastomers. These thermoplastic elastomers can be used individually or in combination of two or more kinds thereof.

Examples thereof include, of SEBSs in the Tuftec (registered trademark) series manufactured by Asahi Kasei Corporation, H1521 [MFR: 2.3 g/10 min], H1051 [MFR: less than 0.8 g/10 min], H1052 [MFR: less than 13.0 g/10 min], H1272 [MFR: No Flow], P1083 [MFR: 3.0 g/10 min], P1500 [MFR: 4.0 g/10 min], P5051 [MFR: 3.0 g/10 min], and P2000 [MFR: 3.0 g/10 min].

Further, Examples thereof include, of SBSs in the Tufprene (registered trademark) series manufactured by Asahi Kasei Corporation, A [MFR: 2.6 g/10 min], 125 [MFR: 4.5 g/10 min], and 126S [MFR: 4.5 g/10 min].

Examples thereof include, of SBSs in the Asaprene (registered trademark) T series manufactured by Asahi Kasei Corporation, T-411 [MFR: No Flow], T-432 [MFR: No Flow], T-437 [MFR: No Flow], T-438 [MFR: No Flow], and T-439 [MFR: No Flow].

Examples thereof include, of SEPSs in the SEPTON (registered trademark) series manufactured by KURARAY CO., LTD., 2002 [MFR: 70 g/10 min], 2004F [MFR: 5 g/10 min], 2005 [MFR: No Flow], 2006 [MFR: No Flow], 2063 [MFR: 7 g/10 min], and 2104 [MFR: 0.4 g/10 min]. The measurement conditions of the MFR of all of these SEPSs are at a temperature of 230° C. and under a load of 2.16 kg.

Examples thereof include, of SEEPSs in the SEPTON (registered trademark) series manufactured by KURARAY CO., LTD., 4033 [MFR: <0.1 g/10 min], 4044 [MFR: No Flow], 4055 [MFR: No Flow], 4077 [MFR: No Flow], and 4099 [MFR: No Flow]. The measurement conditions of the MFR of all of these SEEPSs are at a temperature of 230° C. and under a load of 2.16 kg.

Examples thereof include, of vinyl SISs in the HYBRAR (registered trademark) series manufactured by KURARAY CO., LTD., 5125 [MFR: 4 g/10 min] and 5127 [MFR: 5/10 min].

Examples thereof include, of EVAs in the Ultrathene (registered trademark) series manufactured by Tosoh Corporation, 514R [MFR: 0.41 g/10 min], 515 [MFR: 2.5 g/l10 min], 510 [MFR: 2.5 g/l10 min], 510F [MFR: 2.5 g/l10 min], 520F [MFR: 2.0 g/10 min], 540 [MFR: 3.0 g/10 min], 540F [MFR: 3.0 g/10 min], 537 [MFR: 8.5 g/10 min], 537L [MFR: 8.5 g/10 min], 5375-2 [MFR: 8.5 g/10 min], 541 [MFR: 9.0 g/10 min], 541L [MFR: 9.0 g/10 min], 530 [MFR: 75 g/10 min], 526 [MFR: 25 g/10 min], 630 [MFR: 1.5 g/10 min], 631 [MFR: 1.5 g/10 min], 636 [MFR: 2.5 g/10 min], 625 [MFR: 14 g/10 min], 626 [MFR: 3.0 g/10 min], 627 [MFR: 0.8 g/10 min], 633 [MFR: 20 g/10 min], 635 [MFR: 2.4 g/10 min], 640 [MFR: 2.8 g/10 min], 634 [MFR: 4.3 g/10 min], 680 [MFR: 160 g/10 min], 681 [MFR: 350 g/10 min], 751 [MFR: 5.7 g/10 min], 710 [MFR: 18 g/10 min], 720 [MFR: 150 g/10 min], 722 [MFR: 400 g/10 min], 750 [MFR: 30 g/10 min], 752 [MFR: 60 g/10 min], and 760 [MFR: 70 g/10 min].

As the middle layer 51, a polyolefin-based resin, a long-chain alkyl-based resin, or the like, in addition to the thermoplastic elastomer, may be used.

Examples of the polyolefin-based resin include SURFLEN (registered trademark) P-1000 manufactured by Mitsubishi Chemical Group. Examples of the long chain alkyl-based resin include 1010, 1010S, 1050, 1070, 406, and the like in the PEELOIL (registered trademark) series manufactured by LION SPECIALTY CHEMICALS CO., LTD.

The middle layer 51 can be formed, for example, by applying, on the first thermal transfer layer 50, a coating material obtained by dissolving or dispersing a forming material for the middle layer 51 in any solvent, and then drying the coating material.

### (5) Second Thermal Transfer Layer 52

The second thermal transfer layer 52 can be made of, for example, any thermoplastic resin. Examples of the thermoplastic resin used for the second thermal transfer layer 52 include an epoxy resin, a polyester resin, a polyolefin resin, and the like. The thermoplastic resin can be appropriately selected according to a forming material or the like for the printer tape 2. In a case where the first thermal transfer layer 50 is made of the epoxy resin, it is preferable that the second thermal transfer layer 52 is also made of the epoxy resin similarly.

The adhesion of the first thermal transfer layer 50 to the base material layer 48 and the middle layer 51 and the adhesion of the second thermal transfer layer 52 to the printer tape 2 can be balanced by making the second thermal transfer layer 52 of the epoxy resin. Consequently, at the time of high-temperature transfer, both the first thermal transfer layer 50 and the middle layer 51 can be favorably separated toward the base material layer 48 side, and the second thermal transfer layer 52 can be favorably separated toward the printer tape 2 side. Since the high-temperature transfer range can be widened to the low temperature side, the effect of preventing the color tone from becoming dusky can be further improved. Examples of the epoxy resin include various epoxy resins exemplified as the epoxy resin of the first thermal transfer layer 50. These epoxy resins can be used individually or in combination of two or more kinds thereof.

The second thermal transfer layer 52 may contain wax in addition to the thermoplastic resin. The wax contained in the second thermal transfer layer enables both the first thermal transfer layer 50 and the middle layer 51 to be favorably separated toward the base material layer 48 side and enables the second thermal transfer layer 52 to be favorably separated toward the printer tape 2 side at the time of high-temperature transfer. Therefore, since the high-temperature transfer range can be widened to the low temperature side, the effect of preventing the color tone from becoming dusky can be further improved.

As the wax, any wax having affinity with or compatibility with a thermoplastic resin such as an epoxy resin can be used. For example, natural wax such as carnauba wax, paraffin wax, and microcrystalline wax, and synthetic wax such as Fischer Tropsch wax can be used. Specific examples of the wax are not particularly limited, and include carnauba wax No. 1 flake, No. 2 Flake, No. 3 Flake, No. 1 Powder and No. 2 Powder (melting points of all the products: 80 to 86° C.) manufactured by TOYOCHEM CO., LTD., EMUSTAR-1155 (melting point: 69° C.), EMUSTAR-0135 (melting point: 60° C.), EMUSTAR-0136 (melting point: 60° C.) and the like which are paraffin wax products manufactured by NIPPON SEIRO CO., LTD., EMUSTAR-0001 (melting point: 84° C.), EMUSTAR-042X (melting point: 84° C.) and the like which are microcrystalline wax products manufactured by NIPPON SEIRO CO., LTD., FNP-0090 (condensation point: 90° C.), SX80 (condensation point: 83° C.), FT-0165 (melting point: 73° C.), FT-0070 (melting point: 72° C.), and the like which are Fischer Tropsch wax products manufactured by NIPPON SEIRO CO., LTD. These wax products can be used individually or in combination of two or more kinds thereof.

The second thermal transfer layer 52 may contain any colorant. As the colorant, one or more kinds of various colorants corresponding to the color tone of the second thermal transfer layer 52 can be used. For example, pigments may be used as the colorants. In consideration of improvement or the like in weather resistance of a character, the pigments are preferable as the colorants used in the second thermal transfer layer 52. Examples of the pigments for coloring the second thermal transfer layer 52 into red include the following various red pigments. These red pigments can be used individually or in combination of two or more kinds thereof.

Examples thereof include C.I. Pigment Red 5, 7, 9, 12, 48 (Ca), 48 (Mn), 49, 52, 53, 53:1, 57 (Ca), 57:1, 97, 112, 122, 123, 149, 168, 177, 178, 179, 184, 202, 206, 207, 209, 242, 254, and 255.

Ratios of components in the second thermal transfer layer 52 are not particularly limited. A ratio of the wax with respect to 100 parts by mass of the epoxy resin is, for example, 3 parts by mass or more, and preferably 5 parts by mass or more. The ratio of the wax with respect to 100 parts by mass of the epoxy resin is, for example, 11 parts by mass or less, and preferably 9 parts by mass or less. The ratio of the wax with respect to 100 parts by mass of the epoxy resin is, for example, 3 parts by mass or more and 11 parts by mass or less, and preferably 5 parts by mass or more and 9 parts by mass or less.

A ratio of the colorant such as a red pigment with respect to 100 parts by mass of the epoxy resin is, for example, 70 parts by mass or more, and preferably 80 parts by mass or more. The ratio of the colorant such as the red pigment with respect to 100 parts by mass of the epoxy resin is, for example, 140 parts by mass or less, and preferably 120 parts by mass or less. The ratio of the colorant such as the red pigment with respect to 100 parts by mass of the epoxy resin is, for example, 70 parts by mass or more and 140 parts by mass or less, and preferably 80 parts by mass or more and 120 parts by mass or less.

The second thermal transfer layer 52 can be formed, for example, by applying, on the middle layer 51, a coating material obtained by dissolving or dispersing the above components in any solvent and then drying the coating material.

### [Thickness of Each Layer of Thermal Transfer Recording Medium 47]

One of the characteristics of the thermal transfer recording medium 47 according to a preferred embodiment of the present disclosure is that a total thickness of a transferred product separated from the base material layer 48 by the thermal transfer at the time of high-temperature heating is thicker than any layer (excluding the base material layer 48) remaining without being separated from the base material layer 48. Hereinafter, the heating step and the cooling step illustrated in FIGS. 1 to 4A and 4B will be described in detail, and the characteristic of the thickness of the thermal transfer recording medium 47 will be described.

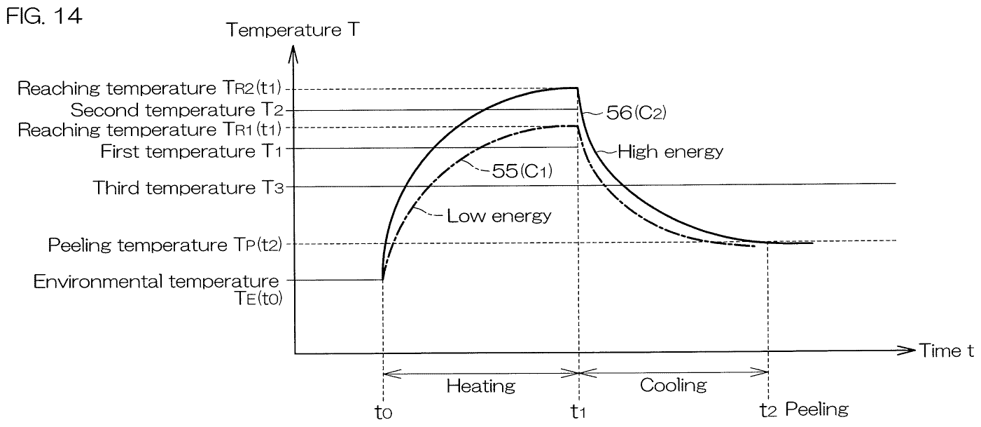

FIG. 14 is a graph illustrating a relationship between an elapsed time and a reaching temperature of the thermal transfer recording medium 47 in the heating step and the cooling step illustrated in FIGS. 1 to 4A and 4B.

The horizontal axis in FIG. 14 represents an elapsed time of the printing step of the printing device 1. Here, to represents a printing start time point, t₁ represents a heating end time point by the thermal head 6, and t₂ represents an arrival time point at the ink ribbon peeling member 13. The vertical axis in FIG. 14 represents the reaching temperature of the thermal transfer recording medium 47. The reaching temperature of the thermal transfer recording medium 47 can be defined as a temperature of the thermal transfer recording medium 47 that changes due to an external factor. The external factor may include, for example, heating by the thermal head 6, natural cooling during transport of the thermal transfer recording medium 47, and the like.

With reference to FIG. 14, in the printing device 1, the control circuit 22 controls a temperature output (temperature energy) of the thermal head 6, and thereby the reaching temperature of the thermal transfer recording medium 47 can be controlled. For example, a relatively low first energy amount is applied to the thermal head 6 in the heating step. The temperature of the thermal transfer recording medium 47 in this case exponentially increases from an environmental temperature (for example, room temperature) T_{E} around the thermal transfer recording medium 47 and reaches T_{R1}, as illustrated by a first temperature curve 55 represented by a dash-dotted line.

The reaching temperature T_{R1} may be defined as a temperature equal to or higher than the first temperature T₁ and equal to or lower than the second temperature T₂. For example, the first temperature T₁ is 60° C. or higher and 120° C. or lower, and preferably 70° C. or higher and 90° C. or lower. For example, the second temperature T₂ is 80° C. or higher and 180° C. or lower, and preferably 130° C. or higher and 150° C. or lower. The reaching temperature T_{R1} can be appropriately set according to an output setting method of the thermal head 6 of the printing device 1 to be used. For example, the reaching temperature may be set in association with quantitative parameters such as an energization time, or a voltage or a current which is to be supplied to the heating body 20 of the thermal head 6. In addition, the reaching temperature may be set in association with a relative numerical value with respect to a predetermined reference value (for example, 0 (zero) or the like as a numerical value before energization).

On the other hand, in the heating step, a second energy amount relatively higher than the first energy amount is applied to the thermal head 6. The temperature of the thermal transfer recording medium 47 in this case exponentially increases from the environmental temperature T_{E} and reaches T_{R2} as illustrated by a second temperature curve 56 represented by a solid line. The reaching temperature T_{R2} may be defined as a temperature exceeding the second temperature T₂.

After the heating step, the thermal transfer recording medium 47 is naturally cooled in a zone provided until the reach of the ink ribbon peeling member 13 (see also FIGS. 3 and 4A and 4B). In the cooling step, the temperature of the thermal transfer recording medium 47 exponentially decreases from the reaching temperatures T_{R1} and T_{R2} to reach T_{P}. The reaching temperature T_{P} at this time is a temperature at which a part of the thermal transfer recording medium 47 is peeled by the ink ribbon peeling member 13, and thus may be defined as the peeling temperature T_{P}. The peeling temperature T_{P} is preferably equal to or lower than a third temperature T₃. The third temperature T₃ is lower than the first temperature T₁ (that is, the first temperature T₁ is equal to or higher than the third temperature T₃), and is, for example, 40° C. or higher and 90° C. or lower, and preferably 60° C. or higher and 80° C. or lower. Magnitudes of the first temperature T₁, the second temperature T₂, and the third temperature T₃ can be appropriately set within a temperature range suitable for performing transfer to the printer tape 2 in consideration of the chemical composition and physical properties of ink of the thermal transfer recording medium 47.

A temperature curve (cooling curve) of the thermal transfer recording medium 47 in the cooling step finally converges to a constant temperature through any heating control represented by the first temperature curve 55 and the second temperature curve 56 in the heating step. Hence, the peeling temperatures T_{P} of the first temperature curve 55 and the second temperature curve 56 can be made substantially the same, by securing a long time (t₁→t₂) for the cooling step. In order to lengthen the time of the cooling step, for example, a distance (peeling distance L₁ in FIG. 1) between the thermal head 6 and the ink ribbon peeling member 13 may be lengthened. For example, a state of the thermal transfer recording medium 47 after the heating step and the cooling step are executed due to a temperature change represented by the first temperature curve 55 in FIG. 14 may be defined as a first state C₁. In this respect, a state of the thermal transfer recording medium 47 after the heating step and the cooling step are executed due to a temperature change represented by the second temperature curve 56 in FIG. 14 may be defined as a second state C₂.

As described above, in the printing device 1, in a process from the start of the heating step to the end of the cooling step, control of the temperature output (temperature energy) of the thermal head 6 enables the reaching temperature of the thermal transfer recording medium 47 to variously change while a start temperature (environmental temperature T_{E}) and a final temperature (peeling temperature T_{P}) are maintained constant. In consideration of this temperature control, for example, the temperature output of the thermal head 6 is controlled depending on the individual physical properties of the base material layer 48, the back surface layer 49, the first thermal transfer layer 50, the middle layer 51, and the second thermal transfer layer 52 of the thermal transfer recording medium 47 in FIG. 13, and thereby it is expected to control adhesive forces between the individual layers of the thermal transfer recording medium 47.

Accordingly, the thermal transfer recording medium 47 satisfies a condition that a total thickness of all the layers that are ruptured in the second state C₂ and are separated from the base material layer 48 side (the total thickness of the transferred product) is thicker than any layer before thermal transfer (t₀) excluding the base material layer 48 in a portion remaining without being separated from the base material layer 48. In this preferred embodiment, the above condition can be satisfied by adjusting the thicknesses of the layers of the first thermal transfer layer 50, the middle layer 51, and the second thermal transfer layer 52. Note that the thicknesses of the first thermal transfer layer 50, the middle layer 51, and the second thermal transfer layer 52 can be checked based on, for example, the scanning electron microscope (SEM) image, the transmission electron microscope (TEM) image, or the like of the thermal transfer recording medium 47.

The thickness of the first thermal transfer layer 50 can be adjusted by an application amount of the first thermal transfer layer 50. For example, the application amount of the first thermal transfer layer 50 is 0.1 g/m² or more, and preferably 0.5 g/m² or more in terms of a solid content per unit area. For example, the application amount of the first thermal transfer layer 50 is 3.0 g/m² or less, and preferably 2.5 g/m² or less in terms of the solid content per unit area. For example, the application amount of the first thermal transfer layer 50 is 0.1 g/m² or more and 3.0 g/m² or less, and preferably 0.5 g/m² or more and 2.5 g/m² or less in terms of the solid content per unit area. A specific thickness (before printing) of the first thermal transfer layer 50 may be, for example, 0.05 μm or more and 3.0 μm or less, and preferably 0.5 μm or more and 2.5 μm or less.

For example, the thickness of the middle layer 51 can be adjusted by an application amount of the middle layer 51. For example, the application amount of the middle layer 51 is 0.1 g/m² or more, and preferably 0.2 g/m² or more in terms of a solid content per unit area. For example, the application amount of the middle layer 51 is 2.0 g/m² or less, and preferably 1.5 g/m² or less in terms of the solid content per unit area. For example, the application amount of the middle layer 51 is 0.1 g/m² or more and 2.0 g/m² or less, and preferably 0.2 g/m² or more and 1.5 g/m² or less in terms of the solid content per unit area. A specific thickness (before printing) of the middle layer 51 may be, for example, 0.05 μm or more and 2.0 μm or less, and preferably 0.2 μm or more and 1.5 μm or less. The middle layer 51 is preferably thinner than the first thermal transfer layer 50 and the second thermal transfer layer 52. This is because, if the middle layer 51 containing no colorant such as a pigment is too thick, film tearability may deteriorate, and the sharpness of the recording pattern may deteriorate.

The thickness of the second thermal transfer layer 52 can be adjusted by an application amount of the second thermal transfer layer 52. For example, the application amount of the second thermal transfer layer 52 is 0.2 g/m² or more, and preferably 1.0 g/m² or more in terms of a solid content per unit area. For example, the application amount of the second thermal transfer layer 52 is 7.0 g/m² or less, and preferably 5.0 g/m² or less in terms of the solid content per unit area. For example, the application amount of the second thermal transfer layer 52 is 0.2 g/m² or more and 7.0 g/m² or less, and preferably 1.0 g/m² or more and 5.0 g/m² or less in terms of the solid content per unit area. A specific thickness (before printing) of the second thermal transfer layer 52 may be, for example, 0.05 μm or more and 7.0 μm or less, and preferably 1.0 μm or more and 5.0 μm or less.

Note that the total thickness of the transferred product is preferably 12 μm or less. This is because, when the total thickness of the transferred product exceeds 10 μm, it is necessary to set the heating temperature of the thermal head 6 high, and a service life of the thermal head 6 may be impaired. In addition, when the thickness of the first thermal transfer layer 50 (in this preferred embodiment, black) and the thickness of the second thermal transfer layer 52 (in this preferred embodiment, red) are extremely different from each other (for example, a thickness difference of four times or more), red has a strong influence even in black printing, and black may be unclear. Hence, it is necessary to adjust the thicknesses of the first thermal transfer layer 50 and the second thermal transfer layer 52, the selection of the colorant, and the like within a range of an appropriate application amount.

### [Peeling Mode of Thermal Transfer Recording Medium 47]

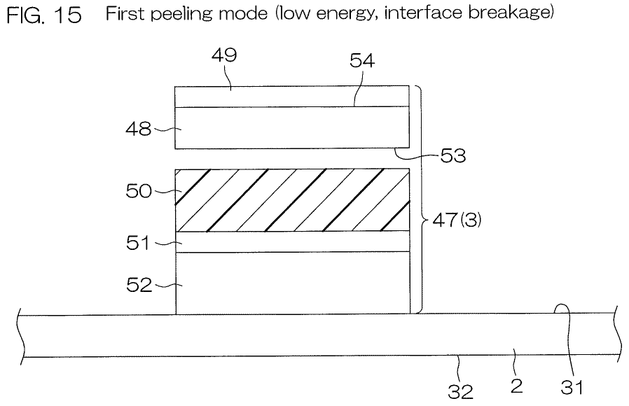

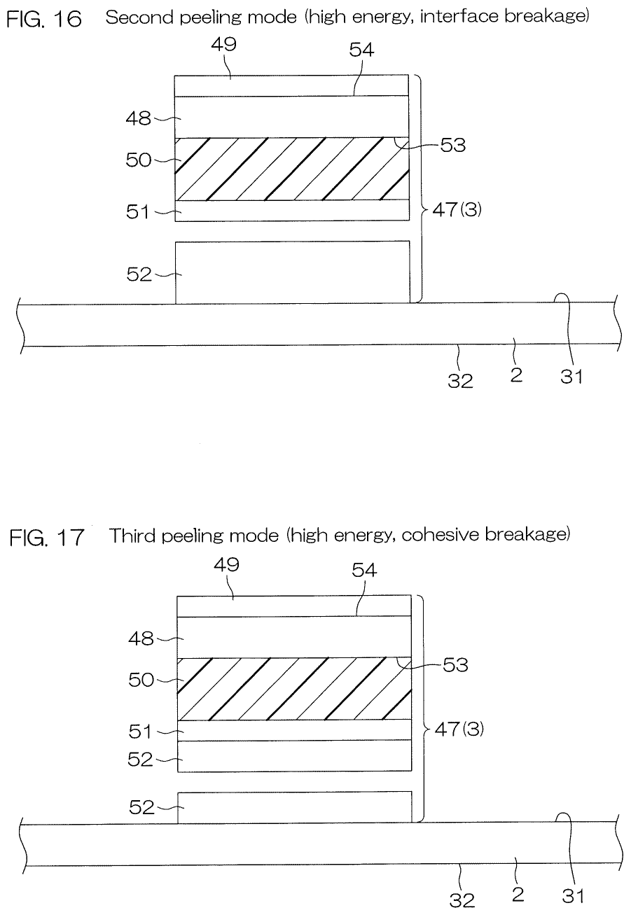

FIGS. 15 to 19 are views illustrating respective peeling states of the thermal transfer recording medium 47. With reference to FIGS. 15 to 19, the thermal transfer recording medium 47 includes a plurality of peeling modes. The peeling modes of FIGS. 15 to 19 may be sequentially referred to as first to fifth peeling modes. From the viewpoint of the energy supplied to the thermal head 6, it is possible to distinguish between low energy peeling modes illustrated in FIG. 15 and high energy peeling modes illustrated in FIGS. 16 to 19.

FIG. 15 illustrates the peeling mode when the peeling (thermal transfer) is performed in the first state C₁ through the heating control (low energy application) of the first temperature curve 55 in FIG. 14. In the first peeling mode in FIG. 15, the thermal transfer recording medium 47 has the lowest rupture strength between the base material layer 48 and the first thermal transfer layer 50 in the first state C₁, and peeling occurs at an interface between these layers. The first peeling mode in FIG. 15 is an interface breakage. According to the peeling mode in FIG. 15, the first thermal transfer layer 50 and the second thermal transfer layer 52 in an adhering state are transferred to the printer tape 2.

FIGS. 16 to 19 illustrate the peeling modes when the peeling (thermal transfer) is performed in the second state C₂ through the heating control (high energy application) of the second temperature curve 56 in FIG. 14. The peeling modes in FIGS. 16 to 19 can also be distinguished into at least two breakage modes of the interface breakage and the cohesive breakage.

In the second peeling mode in FIG. 16, the thermal transfer recording medium 47 has the lowest rupture strength between the first thermal transfer layer 50 and the second thermal transfer layer 52 in the second state C₂, and peeling occurs at an interface between these layers (interface breakage). In the third peeling mode in FIG. 17, the thermal transfer recording medium 47 has the lowest rupture strength in the second thermal transfer layer 52 in the second state C₂, and peeling occurs inside the second thermal transfer layer 52 (cohesive breakage).

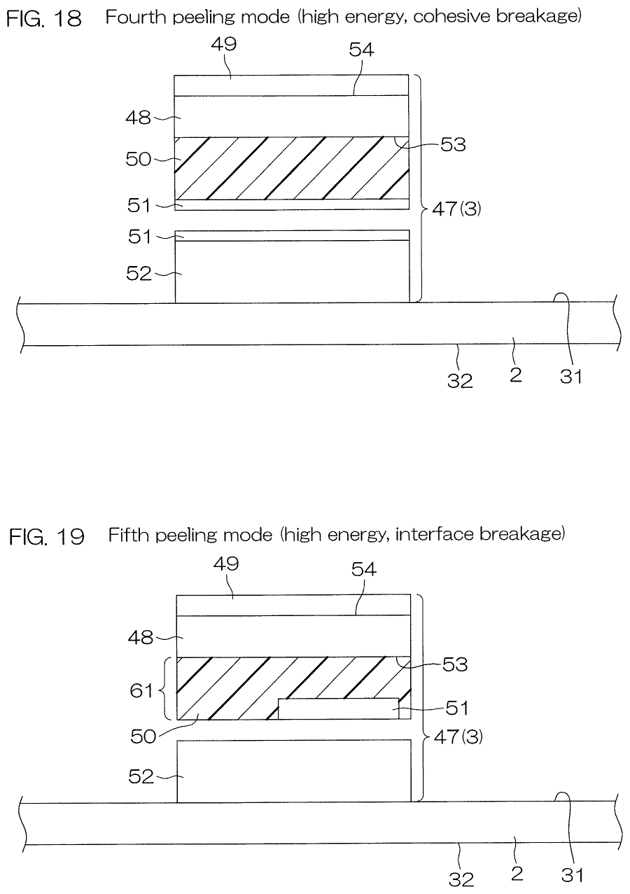

In the fourth peeling mode in FIG. 18, the thermal transfer recording medium 47 has the lowest rupture strength in the middle layer 51 in the second state C₂, and peeling occurs inside the middle layer 51 (cohesive breakage). In the fifth peeling mode in FIG. 19, in the second state C₂, a layer in contact with the second thermal 10 transfer layer 52 is a mixed layer 61 in which the components of the first thermal transfer layer 50 and the middle layer 51 are melted and mixed. Accordingly, the thermal transfer recording medium 47 has the lowest rupture strength between the mixed layer 61 and the second thermal transfer layer 52, and peeling occurs at an interface between these layers (interface breakage).

In all of the peeling modes in FIGS. 16 to 19, the second thermal transfer layer 52 is selectively transferred to the printer tape 2 so that the first thermal transfer layer 50 does not remain.

Whether the thermal transfer recording medium 47 is ruptured in any of the peeling modes in FIGS. 15 to 19 can be checked by, for example, observing a cross section of the thermal transfer recording medium 47 after the rupture. For example, this can be checked based on, for example, a scanning electron microscope (SEM) image, a transmission electron microscope (TEM) image, or the like of the thermal transfer recording medium 47 after the rupture.

As described above, in the first peeling mode, the characters to be recorded on the printing surface 31 of the printer tape 2 have the color tone of the first thermal transfer layer 50, for example, black. In the second to fifth peeling modes, the characters to be recorded on the printing surface 31 of the printer tape 2 have the color tone of the second thermal transfer layer 52, for example, red.

### EXAMPLES

Hereinafter, the present disclosure will be further described based on a plurality of samples, but the configuration of the present disclosure is not limited to these examples.

### [Coating Material for First Thermal Transfer Layer]

Individual components illustrated in Table 1 below were dissolved in a mixed solvent of toluene and methyl ethyl ketone (MEK) at a mass ratio of 1/4 to prepare a coating material for the first thermal transfer layer having a solid content concentration of 22.5 mass %. A ratio of the active component in the acrylic adhesive was 80 parts by mass with respect to 100 parts by mass of the epoxy resin.

TABLE 1

| Components | Parts by mass |
|---|---|
| Epoxy resin | 100 |
| Acrylic adhesive | 200 |
| Tackifier | 28.3 |
| Carbon black | 166.7 |

The components in the table are as follows.

Epoxy resin: JER1007 [basic solid type, softening point (ring-and-ball method): 128° C., number average molecular weight Mn: about 2,900] manufactured by Mitsubishi Chemical Group

Acrylic adhesive: AS-665 [solid content concentration: 40 mass %] manufactured by LION SPECIALTY CHEMICALS CO., LTD.

Tackifier: Terpene phenolic resin, YS POLYSTER T80 (softening point: 80±5° C.) manufactured by YASUHARA CHEMICAL Co., Ltd.

Carbon black: MA100 Powder form [LFF, DBP absorption number: 100 cm³/100 g] manufactured by Mitsubishi Chemical Group

### [Coating Material (1) for Middle Layer]

A thermoplastic elastomer [Tuftec H1521, SEBS, MFR: 12.3 g/10 min, 18 mass % of percentage styrene content, manufactured by Asahi Kasei Corporation] was dissolved in a mixed solvent of toluene and hexane at a mass ratio of 1/1 to prepare a coating material (1) for the middle layer having a solid content concentration of 10 mass %.

### [Coating Material (2) for Middle Layer]

A middle layer coating material (2) was prepared in the same manner as the middle layer coating material (1) except that the same amount of a modified polyolefin resin [SURFLEN (registered trademark) P-1000 manufactured by Mitsubishi Chemical Group] was blended instead of the thermoplastic elastomer. The solid content concentration was 10 mass %.

### [Coating Material for Second Thermal Transfer Layer]

Individual components illustrated in Table 2 below were dissolved in a mixed solvent of toluene and MEK at a mass ratio of 1/4 to prepare a coating material for the second thermal transfer layer having a solid content concentration of 28 mass %.

TABLE 2

| Components | Parts by mass |
|---|---|
| Epoxy resin | 100 |
| Wax | 7.1 |
| Red pigment | 92.9 |

The components in the table are as follows.

Epoxy resin: JER1004 [basic solid type, softening point (ring-and-ball method): 97° C., number average molecular weight Mn: about 1,650] manufactured by Mitsubishi Chemical Group

Wax: Carnauba wax No. 2 Powder (Melting point: 80 to 86° C.) manufactured by TOYOCHEM CO., LTD.

Red pigment: C.I. Pigment Red 53:1 [SYMULER (registered trademark) Lake Red C-102 manufactured by DIC CORPORATION]

### [Samples 1 to 7]

### (1) Manufacture of Thermal Transfer Recording Medium

First, a PET film having a thickness of 4.5 μm was prepared as a base material layer. Next, a back surface layer made of a silicone-based resin and having a solid content of 0.1 g/m² per unit area was formed on a surface (back surface) of the base material layer opposite to a front surface on which a thermal transfer layer was to be formed. Next, a coating material for a first thermal transfer layer which was previously prepared was obtained by adjusting a solid content per unit area to have a thickness shown in Table 3 below, was applied to the front surface of the base material layer, and then was dried to form a first thermal transfer layer. Next, any one coating material for a middle layer which was previously prepared was obtained by adjusting a solid content per unit area to have a thickness shown in Table 3 below, was applied on the first thermal transfer layer, and then was dried to form a middle layer. Next, a coating material for a second thermal transfer layer which was previously prepared was obtained by adjusting a solid content per unit area to have a thickness shown in Table 3 below, was applied on the middle layer, and then was dried to form a second thermal transfer layer such that a thermal transfer recording medium was manufactured. The compositions of the individual layers of the thermal transfer recording medium obtained in each of the samples 1 to 7 are as shown in Tables 3 below.

### (2) Evaluation

### (2-1) Evaluation of Fringe Printability

The thermal transfer recording medium manufactured in each sample was slit into a ribbon shape having a predetermined width, wound in a roll shape, and set in a thermal transfer printer [Prototype Printer manufactured by BROTHER INDUSTRIES, LTD.]. Main specifications of the thermal transfer printer are as follows.
<Resolution>300 dpi Line Thermal Head
<Resistance Value of Heating Body>1,830 Ω
<Transfer Load>30 N/2 inch
<Transport Speed>20 mm/sec
<Peeling Distance>110 mm

Next, an energy value which was set in advance in the thermal transfer printer and applied to a thermal head was set to high energy (0.34 mJ/dot: 25 V (0.34 W/dot)/1,000 sec, red), in an environment with an outside temperature of 25° C., and a predetermined printing pattern was recorded on a front surface of a label material for printing variable information [polyester film (white, glossy), FR1415-50 manufactured by LINTEC Corporation]. The printing pattern was a pattern in which a large number of squares of five dots×five dots were arranged to form polka dots at intervals. Accordingly, one polka dot in a printed pattern was enlarged and observed with a microscope. An area ratio (black/red+black) of an image printed in red and an image printed in black (circumferential edge) in the polka dot was calculated, and the printability of fringes was evaluated based on the following criteria.

◯: The area ratio was lower than 10%.

Δ: The area ratio was 10% or higher and lower than 20%.

X: The area ratio was 20% or higher.

### (2-2) Evaluation of Sharpness of Recording

The thermal transfer recording medium manufactured in each sample was slit into a ribbon shape having a predetermined width, wound in a roll shape, and set in a thermal transfer printer [Prototype Printer manufactured by BROTHER INDUSTRIES, LTD.] having the same specifications as those of (2-1). Next, an energy value which was set in advance in the thermal transfer printer and applied to a thermal head was individually set to low energy (0.25 mJ/dot: 25 V (0.34 W/dot)/750 sec, black) or high energy (0.34 mJ/dot: 25 V (0.34 W/dot)/1,000 sec, red), in an environment with an outside temperature of 25° C., and a barcode was recorded on a front surface of a label material for printing variable information [polyester film (white, glossy), FR1415-50 manufactured by LINTEC Corporation]. Accordingly, a decodability grade prescribed in American National Standards Institute Standard ANSI X3.182-1990) was determined from a result of reading the recorded barcode using a bar-code verifier [Laser Xaminer Elite IS manufactured by Munazo INC.], and sharpness of the recording was evaluated according to the following criteria.

◯: Both black and red had a decodability grade of A [very excellent] or B [excellent].

Δ: One of black or red had a decodability grade of C [good] and the other had a decodability grade of C [good] or higher.

X: At least one of black or red had a decodability grade of D [acceptable] or F [unacceptable].

The results are shown in Tables 3 and 4. Note that, of the samples 1 to 7, the samples 1 to 5 are Examples, and the samples 6 and 7 may be Comparative Examples.

### (2-3) Observation of Rupture Position

The thermal transfer recording medium manufactured in each sample was slit into a ribbon shape having a predetermined width, wound in a roll shape, and set in a thermal transfer printer [Prototype Printer manufactured by BROTHER INDUSTRIES, LTD.] having the same specifications as those of (2-1). Next, an energy value which was set in advance in the thermal transfer printer and applied to a thermal head was individually set to low energy (0.25 mJ/dot: 25 V (0.34 W/dot)/750 sec, black) or high energy (0.34 mJ/dot: 25 V (0.34 W/dot)/1,000 sec, red), in an environment with an outside temperature of 25° C., and a solid image having a size of 70×70 mm² was recorded on a front surface of a label material for printing variable information [polyester film (white, glossy), FR1415-50 manufactured by LINTEC Corporation]. In any case, since the peeling distance of the thermal transfer printer is secured to 110 mm, the thermal transfer printer is sufficiently cooled (60° C. or lower) and then subjected to the peeling treatment. A cross section of the obtained solid image was observed using a transmission electron microscope (TEM: HT7820 with acceleration voltage of 100 kV manufactured by Hitachi High-Technologies Corporation). In each of the black transfer and the red transfer, a position of a rupture in the thermal transfer recording medium was checked. The rupture position was identified in the peeling mode as follows.
First peeling mode: between the base material layer and the first thermal transfer layer (interface breakage, see FIG. 15)
Second peeling mode: between the middle layer and the second thermal transfer layer (interface breakage, see FIG. 16)
Third peeling mode: inside the second thermal transfer layer (cohesive breakage, see FIG. 17)
Fourth peeling mode: inside the middle layer (cohesive breakage, see FIG. 18)
Fifth peeling mode: between the mixed layer and the second thermal transfer layer (interface breakage, see FIG. 19)

The results are shown in Tables 3 and 4. In Tables 3 and 4, each of the first to fifth peeling modes is represented only by a number surrounded by a circle. In addition, in Tables 3 and 4, the case of arranging a plurality of peeling modes indicates that the peeling modes different from each other occur in an in-plane direction of the thermal transfer recording medium. In addition, since the sample 2 has a layer configuration without a middle layer, strictly speaking, a peeling mode of the sample 2 was the peeling mode in a state in which the middle layer 51 was omitted from FIGS. 15, 17, and 19.

TABLE 3

| | | | | Sample 7 | |
|---|---|---|---|---|---|
| | | | Sample 6 | Trans- | |
| | | | First | ferred | |
| | | | thermal | product = | |
| | | Sample 1 | transfer | First | Sample 2 |
| | | Trans- | layer | thermal | Trans- |
| | | ferred | before | transfer | ferred |
| Thickest layer | | product | transfer | layer | product |
| Before | First thermal | 1.5 | 2.5 | 2.0 | 2.0 |
| transfer | transfer layer | | | | |
| | (μm) | | | | |
| | Middle layer | 1.0 | 1.0 | 1.0 | — |
| | (1) (μm) | | | | |
| | SEBS | | | | |
| | Middle layer | — | — | — | — |
| | (2) (μm) | | | | |
| | SURFLEN | | | | |
| | Second thermal | 2.5 | 1.5 | 2.0 | 3.0 |
| | transfer layer | | | | |
| | (μm) | | | | |
| | Total thickness | 5.0 | 5.0 | 5.0 | 5.0 |
| | (μm) | | | | |
| Trans- | Middle layer | — | — | — | — |
| ferred | (μm) | | | | |
| product | Second thermal | 2.5 | 1.5 | 2.0 | 3.0 |
| | transfer layer | | | | |
| | (μm) | | | | |
| | Total thickness | 2.5 | 1.5 | 2.0 | 3.0 |
| | (μm) | | | | |
| Evalu- | Fringe | ∘ | x | x | Δ |
| ation | printability | | | | |
| | Sharpness | ∘ | ∘ | ∘ | Δ |
| | Peeling mode | \textcircled{1} | \textcircled{1} | \textcircled{1} | \textcircled{1} |
| | (upper row: | \textcircled{2} | \textcircled{2} | \textcircled{2} | \textcircled{3} + \textcircled{5} |
| | black, lower | | | | |
| | row: red) | | | | |

TABLE 4

| | | Sample 3 | | |
|---|---|---|---|---|
| | | Second | Sample 4 | Sample 5 |
| | | thermal | Trans- | Trans- |
| | | transfer | ferred | ferred |
| Thickest layer | | layer | product | product |
| Before | First thermal transfer | 1.0 | 1.5 | 2.0 |
| transfer | layer (μm) | | | |
| | Middle layer (1) (μm) | 1.5 | — | — |
| | SEBS | | | |
| | Middle layer (2) (μm) | — | 1.0 | 1.0 |
| | SURFLEN | | | |
| | Second thermal | 2.5 | 2.5 | 2.0 |
| | transfer layer (μm) | | | |
| | Total thickness (μm) | 5.0 | 5.0 | 5.0 |
| Transferred | Middle layer (μm) | — | 0.5 | 0.5 |
| product | Second thermal | 2.5 | 2.5 | 2.0 |
| | transfer layer (μm) | | | |
| | Total thickness (μm) | 2.5 | 3.0 | 2.5 |
| Evaluation | Fringe printability | ∘ | ∘ | ∘ |
| | Sharpness | Δ | Δ | Δ |
| | Peeling mode | \textcircled{1} | \textcircled{1} | \textcircled{1} |
| | (upper row: black, | \textcircled{2} | \textcircled{4} | \textcircled{4} |
| | lower row: red) | | | |

From the comparison between the sample 1 and the samples 6 and 7, it has been found that the fringe printability can be improved by making the second thermal transfer layer thicker than the first thermal transfer layer. In the sample 6 and 7, it is considered that the thickness of the second thermal transfer layer is equal to or less than the thickness of the first thermal transfer layer, and as a result, fringes are likely to occur. However, when the sample 7 and the sample 5 are compared with each other, the samples have a similar balance between the layer thicknesses before transfer. However, since the cohesive breakage occurred in the middle layer in the sample 5, the total thickness of the transferred product was increased, and the fringe printability was improved. On the other hand, the sharpness of the sample 5 was inferior to that of the sample 7 since the cohesive breakage occurred in the middle layer.

Regarding the sample 2, in the case where the middle layer is not provided, the first thermal transfer layer and the second thermal transfer layer are in contact with each other to be adjacent, and thus fringes are more likely to occur than in the sample 1. In addition, it was difficult to separate the first thermal transfer layer and the second thermal transfer layer from each other, and as a result, the sharpness deteriorated.

Regarding the sample 3, in a case where the middle layer was formed to be relatively thick, the fringe printability was good. On the other hand, the middle layer was poor in sharpness, and as a result, the sharpness deteriorated due to excessive peeling or the like.

Regarding the sample 4, if the middle layer is made of a material which is cohesively broken, such as a polyolefin, a peeling position in high-temperature printing is located inside the middle layer, and a transferred product is a part of the second thermal transfer layer and the middle layer. Since the cohesive breakage occurred in the middle layer, the sharpness was inferior to the case of using the thermoplastic elastomer (SEBS) for the middle layer.

### REFERENCE SIGNS LIST

1: Printing device
2: Printer tape
3: Ink ribbon
20: Heating body
31: Printing surface
32: Back surface
33: Adhesive surface
34: Back surface
35: Base material layer
36: First ink layer
37: Second ink layer
38: Front surface
39: Back surface
40: First portion
41: Second portion
42: First portion
43: Second portion
44: Printing pattern
45: Red pattern
46: Black pattern
47: Thermal transfer recording medium
48: Base material layer
49: Back surface layer
50: First thermal transfer layer
51: Middle layer
52: Second thermal transfer layer
53: Front surface
54: Back surface
80: Fringe
87: First boundary portion
88: Second boundary portion
89: Third boundary portion
96: First temperature distribution curve
97: Second temperature distribution curve
98: High temperature side boundary condition
99: Low temperature side boundary condition
100: Central portion
101: Circumferential edge portion
C₁: First state
C₂: Second state
F₁: External force
T₁: First temperature
T₂: Second temperature
T₃: Third temperature
T_{R1}: Reaching temperature
T_{R2}: Reaching temperature
T_{b}: Reaching temperature
T0: Ambient temperature
Th: Reaching temperature
T1: Temperature rise value
Tl: Reaching temperature

1. A thermal transfer recording medium formed by layering a base material layer, a first ink layer including first ink, and a second ink layer including second ink in this order in which at least a part of the first ink layer and the second ink layer is thermally transferred to a printing medium, wherein
the thermal transfer recording medium is ruptured between the first ink layer and the base material layer or in the first ink layer when an external force is applied to the base material layer and the second ink layer in a direction in which the layers are separated from each other, in a first state in which the thermal transfer recording medium is heated to a first temperature or higher and a second temperature or lower and then cooled to a third temperature or lower,
the thermal transfer recording medium is ruptured between the first ink layer and the second ink layer or in the second ink layer when the external force is applied in a second state in which the thermal transfer recording medium is heated to a temperature above the second temperature and then cooled to the third temperature or lower, and
a total thickness of all layers that are ruptured in the second state and are separated from the base material layer side is thicker than a thickness of any layer before thermal transfer except for the base material layer in a portion remaining without being separated from the base material layer.

2. The thermal transfer recording medium according to claim 1, wherein the second ink layer is the thickest of all the layers that are ruptured in the second state and are separated from the base material layer side.

3. The thermal transfer recording medium according to claim 1, wherein
the thermal transfer recording medium has the lowest rupture strength between the first ink layer and the base material layer or in the first ink layer when the external force is applied in the first state, and
the thermal transfer recording medium has the lowest rupture strength between the first ink layer and the second ink layer or in the second ink layer when the external force is applied in the second state.

4. The thermal transfer recording medium according to claim 1, wherein
the thermal transfer recording medium includes a middle layer between the first ink layer and the second ink layer, and
the thermal transfer recording medium is ruptured between the middle layer and the second ink layer when the external force is applied in the second state.

5. The thermal transfer recording medium according to claim 4, wherein the thermal transfer recording medium has the lowest rupture strength between the middle layer and the second ink layer when the external force is applied in the second state.

6. The thermal transfer recording medium according to claim 1, wherein
the thermal transfer recording medium includes a middle layer between the first ink layer and the second ink layer, and
the thermal transfer recording medium is ruptured in the middle layer when the external force is applied in the second state.

7. The thermal transfer recording medium according to claim 6, wherein the thermal transfer recording medium has the lowest rupture strength in the middle layer when the external force is applied in the second state.

8. The thermal transfer recording medium according to claim 1, wherein the first temperature is equal to or higher than the third temperature.

9. The thermal transfer recording medium according to claim 1, wherein
the first state is a state in which the base material layer of the thermal transfer recording medium is heated to the first temperature or higher and the second temperature or lower and then cooled to the third temperature or lower, and
the second state is a state in which the base material layer of the thermal transfer recording medium is heated to a temperature above the second temperature and then cooled to the third temperature or lower.

10. A printing device configured to execute:
a heating step of heating a thermal transfer recording medium formed by layering a base material layer, a first ink layer including first ink, and a second ink layer including second ink in this order, in a state where the thermal transfer recording medium is in contact with a printing medium;
a cooling step of cooling the thermal transfer recording medium heated by the heating step; and
a transferring step of transferring at least a part of the first ink and the second ink to the printing medium by applying, in a direction in which the base material layer and the second ink layer are separated from each other, an external force to the base material layer and the second ink layer of the thermal transfer recording medium cooled by the cooling step, wherein
in the heating step and the cooling step,
a first state is set by heating a first portion of the thermal transfer recording medium to a first temperature or higher and a second temperature or lower and then cooling the first portion to a third temperature or lower, and a second state is set by heating a second portion of the thermal transfer recording medium to a temperature above the second temperature and then cooling the second portion to the third temperature or lower, and
in the transferring step,
the thermal transfer recording medium is ruptured between the first ink layer and the base material layer or in the first ink layer in the first portion of the thermal transfer recording medium by applying the external force, and the first ink and the second ink are transferred to the printing medium, and
the thermal transfer recording medium is ruptured between the first ink layer and the second ink layer or in the second ink layer in the second portion of the thermal transfer recording medium by applying the external force, the second ink is transferred to the printing medium, and a total thickness of transferred all layers is thicker than a thickness of any layer excluding the base material layer before thermal transfer in a portion remaining without being separated from the base material layer.

11. A cassette comprising:
the internally provided thermal transfer recording medium according to claim 1; and
an internally provided printing medium to which a part of the thermal transfer recording medium is thermally transferred.

12. The thermal transfer recording medium according to claim 2, wherein
the thermal transfer recording medium has the lowest rupture strength between the first ink layer and the base material layer or in the first ink layer when the external force is applied in the first state, and
the thermal transfer recording medium has the lowest rupture strength between the first ink layer and the second ink layer or in the second ink layer when the external force is applied in the second state.

13. The thermal transfer recording medium according to claim 2, wherein
the thermal transfer recording medium includes a middle layer between the first ink layer and the second ink layer, and
the thermal transfer recording medium is ruptured between the middle layer and the second ink layer when the external force is applied in the second state.

14. The thermal transfer recording medium according to claim 13, wherein the thermal transfer recording medium has the lowest rupture strength between the middle layer and the second ink layer when the external force is applied in the second state.

15. The thermal transfer recording medium according to claim 2, wherein
the thermal transfer recording medium includes a middle layer between the first ink layer and the second ink layer, and
the thermal transfer recording medium is ruptured in the middle layer when the external force is applied in the second state.

16. The thermal transfer recording medium according to claim 15, wherein the thermal transfer recording medium has the lowest rupture strength in the middle layer when the external force is applied in the second state.

17. The thermal transfer recording medium according to claim 2, wherein the first temperature is equal to or higher than the third temperature.

18. The thermal transfer recording medium according to claim 2, wherein
the first state is a state in which the base material layer of the thermal transfer recording medium is heated to the first temperature or higher and the second temperature or lower and then cooled to the third temperature or lower, and
the second state is a state in which the base material layer of the thermal transfer recording medium is heated to a temperature above the second temperature and then cooled to the third temperature or lower.

19. A cassette comprising:
the internally provided thermal transfer recording medium according to claim 2; and
an internally provided printing medium to which a part of the thermal transfer recording medium is thermally transferred.
